(19) United States
(12) Patent Application Publication
(10) Pub. No.: US 2014/0002481 A1
(43) Pub. Date: Jan. 2, 2014

(54) METHOD FOR CONVERTING DATA, DISPLAY DEVICE, COMPUTING DEVICE AND PROGRAM INCORPORATING SAME, AND METHOD FOR OPTIMISING COEFFICIENTS AND DEVICE AND PROGRAM INCORPORATING SAME

(71) Applicants: Benjamin John BROUGHTON, Oxford (GB); Andrew KAY, Oxford (GB); Kenji MAEDA, Osaka (JP); Masayuki NATSUMI, Osaka (JP); Fumitaka SEKI, Osaka (JP)

(72) Inventors: Benjamin John BROUGHTON, Oxford (GB); Andrew KAY, Oxford (GB); Kenji MAEDA, Osaka (JP); Masayuki NATSUMI, Osaka (JP); Fumitaka SEKI, Osaka (JP)

(73) Assignee: SHARP KABUSHIKI KAISHA, Osaka (JP)

(21) Appl. No.: 13/534,162

(22) Filed: Jun. 27, 2012

(51) Int. Cl. G09G 5/02

(52) U.S. Cl. 345/591

(57) ABSTRACT

A method for converting image data within a source gamut into modified image data within a destination gamut, is provided including utilizing a processor to operate on input red-green-blue (RGB) data within the source gamut with a multivariate polynomial function to produce modified RGB data within the destination gamut, wherein the polynomial function includes coefficients optimized in accordance with a predefined criteria such that when displayed on a display device having the destination gamut the modified RGB data have a colour appearance representing a perceptually optimised transform of the input RGB data.

### TECHNICAL FIELD

The invention relates to an image data processing function for use with or incorporated into a display device and, more particularly, a polynomial based function for allowing control of the colour performance of the display device. Further, the invention relates to a method of configuring the polynomial function for optimal colour performance of the display device according to one or more intended target colour performances.

### BACKGROUND ART

The problem of variation of display colour characteristics, from different display types, and from device model to device model, and even from display device to display device of the same type due to manufacturing variability is well known. Also well known is the related problem of different image content, for display on the same display device, being created or encoded according to different display colour standards. FIG. 1 shows an example set of colours depicted in the CIE xy colour space for a source gamut with RGB primary colours and the resulting position of the same input colours when displayed on a destination device with primary colours Rₒᵤₜ, Gₒᵤₜ and Bₒᵤₜ. As can be seen in the figure, the primary colours are moved to their corresponding output position and the other colours, being linearly additive combinations of the R, G and B, are shifted in proportion to their constituent primary values. This means a display device with incorrect primary colour position relative to the source gamut will display all input colours inaccurately relative to the source intention. This is a particular problem for the pale so-called “memory colours” such as greys and skin tones, which the human visual system will perceive as being incorrect if their colour is only slightly shifted from the input intention, despite surrounding colours in the image context being shifted also.

The solution to accurately displaying image content created according to a given standard on a non-standard display, or vice versa is to employ a gamut mapping algorithm (GMA) which converts the input image data (usually in R, G, B data format and typically of 8-bit per colour resolution, into modified Rₒᵤₜ Gₒᵤₜ Bₒᵤₜ data which when input to the display device produces the correct colour prescribed for the input RGB data by the given standard. Many such gamut mapping algorithms exist, and the different techniques used have been found to have different strengths and weaknesses in terms of ease of computation and subjective evaluation of the resulting image quality, for different combinations, of source and destination colour gamut and different image content (Computational Color Technology, Henry R. Kang, Chapter 7.9 (SPIE Press, ISBN-10: 0819461199, 15 Jul. 2006), Dugay, F., Farup, I. and Hardeberg, J. Y. (2008)).

Most gamut mapping algorithms involve a conversion from the device dependent colour space (e.g. RGB data) to a device independent colour space (e.g. the CIE XYZ space), followed by a matrix rotation of the colour co-ordinates to fit the destination gamut and reconversion of the result into the colour space of the destination device (U.S. Pat. No. 4,843,573, Tektronix, 1987; US2011/0255101 A1, Eastman Kodak, 2010). The key feature of any GMA is how it deals with colours in the source gamut which are outside the destination device gamut, and therefore cannot be displayed on the device, and regions in the destination gamut which are outside the source gamut and therefore will remain unused if the input source colours are reproduced as faithfully as possible. A straightforward transformation of source colours to equivalent destination colours, and clipping of the output data values to the available range of the destination device will result in only the overlapping area of the two gamuts being utilised, and different input colours resulting in the same output colour as out-of-destination-gamut colours are moved onto the boundary of the device gamut. This problem is illustrated in FIG. 2, which shows the overlapping and non-overlapping gamut regions, and FIG. 3, which shows the GMA resulting in output colours which match the input colours in the overlapping gamut regions, but out-of-gamut input colours shifting to the device gamut boundary.

In order to prevent the loss of image detail due to data clipping, and retain the full gamut of the destination device to maximise the vividness of output image appearance, GMAs have been developed which perform some linear or nonlinear compression of the input colour data in the device independent colour space to allow input colours to be made more accurate according to the source intention, but retain a degree of relative difference in colours which would otherwise be merged. (Perceptual evaluation of color gamut mapping algorithms. Color Res. Appl., 33: 470-476. doi: 10.1002/col. 20443; US 2011/0255101 A1, Eastman Kodak, 2010; U.S. Pat. No. 6,388,674 B1, Sony, 1999).

One type of perceptually optimised gamut mapping algorithm uses two input data transformation functions, one to accurately map input colours to their source intention point in the destination gamut, and one to retain the full extent of the destination gamut. The output result for a given input colour can then be selected from these two possible outputs, or derived as a blended combination of the two, a function of the input colours proximity to, or probability of being within, a memory colour region (U.S. Pat. No. 6,744,534 B1, Xerox, 2000; U.S. Pat. No. 6,266,165 B1, Lexmark, 1998, US 2010/0194773 A1, Sharp, 2010). The function of this type of method is illustrated in FIG. 4, which shows input colours within a predefined memory colour region having output results which are accurate to the source intention, and input colours on the edge of the source gamut having output results shifted to a corresponding position on the edge of the destination gamut. Input colours between these two regions have a resulting output position partially shifted by an amount proportional to their relative distance from the memory colour region and gamut boundary region. These may be considered a particularly advantageous methods, as it allows the appearance of particular colours to be kept accurate to the source intention, while allowing saturated colours to remain as saturated as the destination device is capable of, maximising the vividness of resulting images. These methods also allow for colour selective vividness “boosts” to be applied, whereby the output appearance of an image may be enhanced for certain device usage situations (e.g. in bright ambient conditions, or for display in retail environment where eye-catching image quality may be more desirable than colour accuracy), by increasing the brightness or saturation of some colours while again keeping the memory colours accurate to the source intention.

The disadvantage of these multiple transformation with blending methods is they are computationally more demanding and require more resource in terms of processing power and/or memory requirement. More computationally efficient gamut mapping algorithms have been proposed which are based on a polynomial function only. These have the advantage that they may be optimised for different display types or display-to-display variations simply by reconfiguring the values of the coefficients to each term of the polynomial, and the polynomial process may be embedded in the display control or driver hardware, with only the coefficient values being kept in re-writable storage. U.S. Pat. No. 6,862,029 B1 (Hewlett-Packard, 1999) discloses a method of making automated display characterisation measurements which are then used to calculate coefficients for a polynomial function which provides the desired voltage-transmission curve for a colour display, the polynomial coefficients being stored in the display data channel. However, this publication only describes use of a univariate polynomial function to control the gradation (“gamma”) curve of each colour component separately. No cross-colour dependence or functionality for adjusting colour gamut is described.

U.S. Pat. No. 8,014,028 B2 (Canon, 2008) describes a similar measurement based configuration of a colour transform function to be used in a colour management system. In this disclosure however, although perceptual gamut mapping functionality is provided, the display measurement data is used to provide a detailed transform based on gamut boundary calculations, rather than simply polynomial coefficients, to the colour translation module and, as described, the colour translation module is required to use a look-up table (LUT) to transform some input colours and interpolate the transforms for other colours.

WO 2008/024710 A2 (Texas Instruments, 2006) describes a gamut mapping process based on “rubber-sheet” polynomial calculation. However, the process disclosed requires conversion of the input RGB data to a hue-lightness-chroma colour space, at which point the lightness and chroma data are input to the polynomial to provide colour conversion at constant hue. Also disclosed is the use of a separate LUT function to provide colour appearance preserving conversion of known memory colours, rather than configuring the polynomial function to provide this selectivity.

It is therefore desirable to provide a colour data transformation process that provides the computational simplicity, low data storage requirement and reconfigurability of a polynomial calculation with the degree of functionality provided by more complex perceptually optimised gamut mapping algorithms, without the need for conversion of source RGB data to some intermediate device independent colour space during the data conversion.

### SUMMARY OF INVENTION

According to an aspect, a method for converting image data within a source gamut into modified image data within a destination gamut, is provided including utilizing a processor to operate on input red-green-blue (RGB) data within the source gamut with a multivariate polynomial function to produce modified RGB data within the destination gamut, wherein the polynomial function includes coefficients optimized in accordance with a predefined criteria such that when displayed on a display device having the destination gamut the modified RGB data have a colour appearance representing a perceptually optimised transform of the input RGB data.

According to another aspect, operation of the polynomial function on the input RGB data produces modified RGB data which are accurate in colour appearance for a range of memory colours, display saturated colours (those which are at edges of the source gamut) at corresponding positions at edges of the destination gamut, and display blended intermediate output colours for colours in between the range of memory colours and the saturated colours in the source gamut.

According to another aspect, the predefined criteria is based on calculating perceptually optimised modified target RGB data values in the destination gamut for a set of input RGB data values in the source gamut, and using a numerical optimisation process to minimise a difference between the modified RGB data values achieved by the polynomial function and the modified target RGB data values.

In another aspect, the method includes changing the polynomial function coefficients in accordance with a performance selector input in order to switch colour performance of the display device.

In yet another aspect, the method includes using a 1-dimensional look-up table (LUT) to convert each of the input R, G and B data values in the input RGB data separately to intermediate R, G and B data values, and subsequently inputting the intermediate R, G and B data values to the polynomial function.

According to another aspect, the method includes changing the LUT in accordance with a performance selector input in order to switch colour performance of the display device.

According to still another aspect, a display a display device is provided which includes drive circuitry which carries out a method.

In accordance with another aspect, a computing device is provided which includes at least one of an image rendering program or image data output processor which carries out a method.

According to another aspect, a computer-readable medium is provided having stored thereon a program which, when executed by a processor, carries out a method.

According to another aspect, a method for optimizing coefficients of a multivariate polynomial function with which input RGB data within a source gamut is to be converted into modified RGB data within a destination gamut is provided, including optimizing the coefficients in accordance with a predefined criteria using a processor such that when displayed on a display device having the destination gamut the modified RGB data have a colour appearance representing a perceptually optimised transform of the input RGB data.

In yet another aspect, the predefined criteria includes minimising a difference between the modified RGB data values achieved by the polynomial function and modified target RGB data values.

According to another aspect, the optimising of the coefficients is performed in conjunction with a 1-dimensional look-up table (LUT) to convert each of the input R, G and B data values in the input RGB data separately to intermediate R, G and B data values, and subsequently inputting the intermediate R, G and B data values to the polynomial function.

In accordance with another aspect, values in the LUT and the polynomial coefficients are optimised sequentially in a feedback loop process.

In still another aspect, an optimiser device is provided including a processor programmed to carry out a method.

In another aspect, a non-transitory, computer-readable medium having stored thereon a program which, when executed by a processor, carries out a method is provided.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is an illustration of differences between an image data source colour intention and resulting performance of a destination display in the CIE 1931 xy colour diagram.

FIG. 2 is a further illustration of differences between an image data source colour intention and resulting performance of a destination display in the CIE 1931 xy colour diagram.

FIG. 3 is an illustration of colour performance of a destination display corrected to approximate the source data intention according to a method of the conventional art.

FIG. 4 is an illustration of colour performance of a destination display corrected to approximate the source data intention according to another method of the conventional art.

FIG. 5 is an example polynomial for use in the process of embodiments of this invention.

FIGS. 6(a), 6(b), 6(c) and 6(d) represent an example calculation of source data to data for input to a destination device having a colour gamut differing to that of the source.

FIG. 7 is an illustration of the image data processing flow of embodiments of this invention.

FIG. 8 is an example set of coefficients for a polynomial used in a process of this invention.

FIGS. 9(a), 9(b) and 9(c) are a set of CIE xy diagrams illustrating the performance of an embodiment of this invention using the coefficients of FIG. 8.

FIG. 10 is an illustration of the image data processing flow of further embodiments of this invention.

FIG. 11 is a plot showing example data value to luminance responses of display which colour performance embodiments of this invention may use as a source intention.

FIGS. 12(a) and 12(b) represent a pair of plots showing an example Pre-LUT data set and resulting input data to luminance performance of an embodiment of this invention.

FIG. 13 is an example set of coefficients for a polynomial used in a process of this invention.

FIGS. 14(a), 14(b) and 14(c) are a set of CIE xy diagrams illustrating the performance of an embodiment of this invention using the coefficients of FIG. 13 and the Pre-LUT data set of FIG. 12.

FIG. 15 is plot of data value to luminance responses illustrating the performance of an embodiment of this invention using the coefficients of FIG. 13 and the Pre-LUT data set of FIG. 12.

FIG. 16 is plot of data value to luminance responses illustrating the performance of an embodiment of this invention using the coefficients of FIG. 13 and the Pre-LUT data set of FIG. 12.

FIG. 17 is an example set of input test colour data values and target modified data values as used in an embodiment of this invention.

FIG. 18 is an illustration of the process flow used in a polynomial coefficient optimisation means embodiment of this invention.

FIG. 19 is an illustration of the process flow used in a polynomial coefficient optimisation means embodiment of this invention.

FIG. 20 is an illustration of the process flow used in a polynomial coefficient optimisation means embodiment of this invention.

FIG. 21 is an illustration of the process flow used in a polynomial coefficient optimisation means embodiment of this invention.

FIG. 22 is an illustration of the process flow used in a polynomial coefficient optimisation means embodiment of this invention.

FIGS. 23(a), 23(b) and 23(c) are examples of the destination device colour performance measurements used by an embodiment of this invention.

FIGS. 24(a), 24(b) and 24(c) are examples of the source intention colour performance values used by an embodiment of this invention.

FIG. 25 is an illustration of the process flow used in a part of a polynomial coefficient optimisation means embodiment of this invention.

FIG. 26 is an illustration of the process flow used in a part of a polynomial coefficient optimisation means embodiment of this invention.

FIG. 27 is an illustration of an exemplary image processor incorporating the image data conversion process described herein.

FIG. 28 represents an exemplary optimiser device which optimises the polynomial function coefficients as described above.

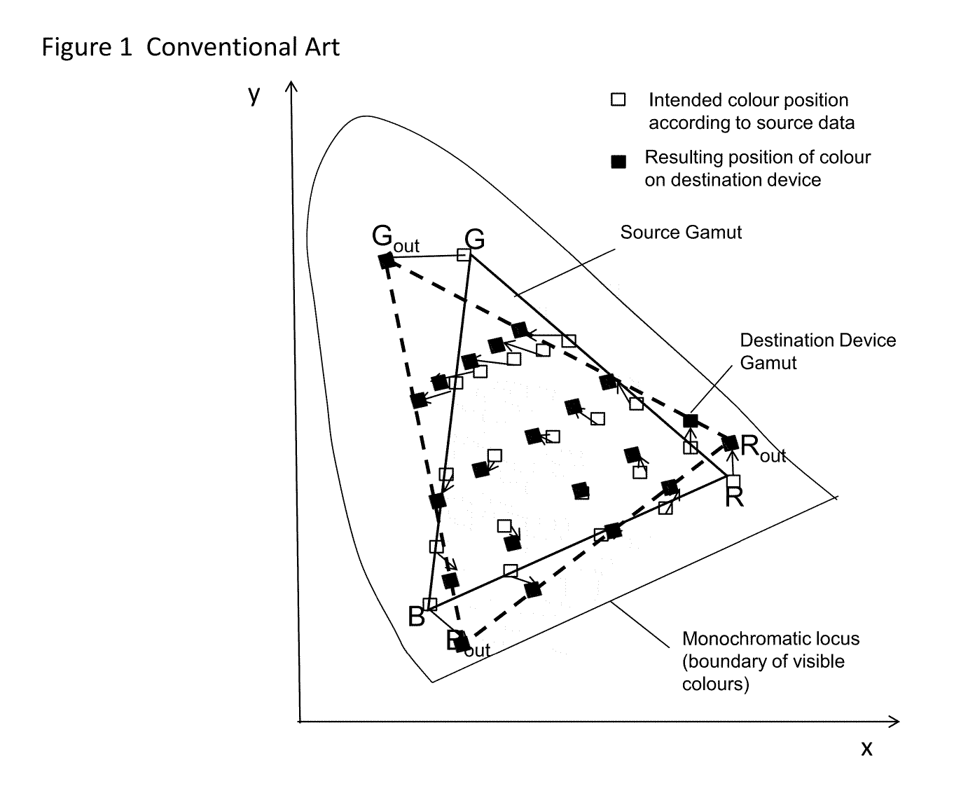

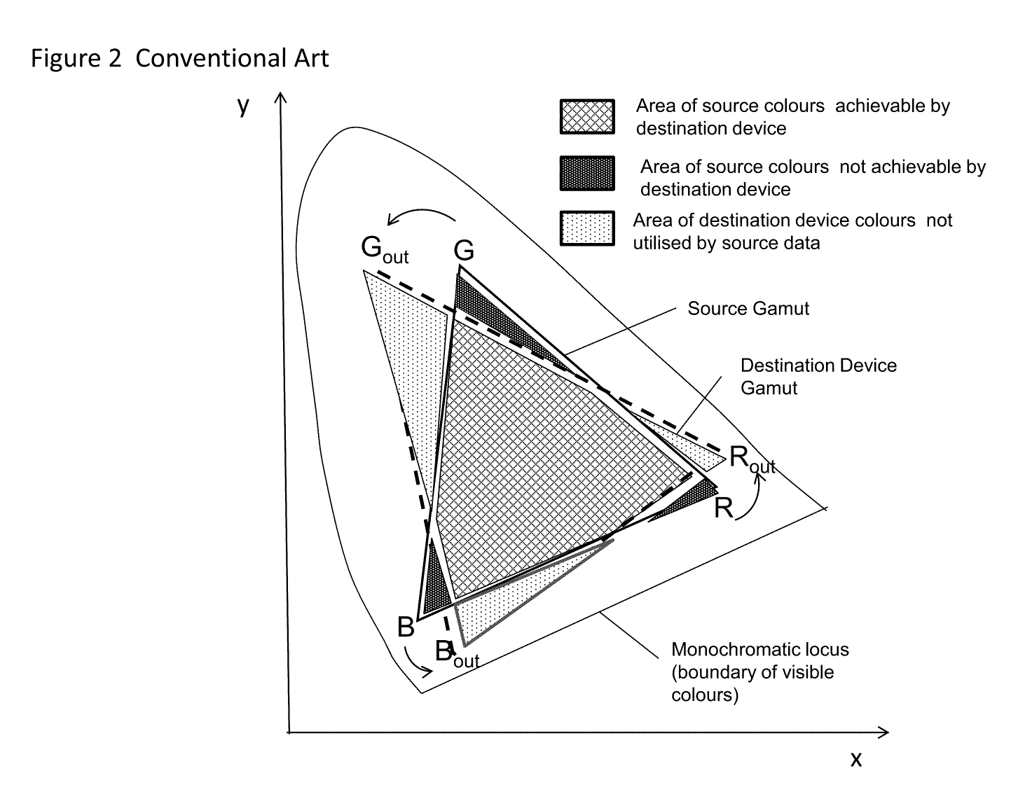

### DESCRIPTION OF REFERENCE NUMERALS

1—Input Sample Colour Set
2—Destination Device RGB to XYZ data
3—Source Intention RGB to XYZ data
4—Gamma Corrected Destination RGB to XYZ values
5—Sample Set Destination Gamma Corrected XYZ values
6—White Point Luminance Scaled Source Intention XYZ Values
7—Saturation based Source and Destination XYZ blending process
8—Sample Set saturation calculation
9—Sample Set Blended Target XYZ values
10—Sample Set Blended Target L*a*b* values
11—Trial Modified RGB data values
12—Predicted XY and L*a*b* values produced by destination device with Trial Modified RGB data values
13—Sample Set Target Modified RGB data values.
14—Sample Set Achieved Modified RGB data values.

### DETAILED DESCRIPTION OF INVENTION

In an embodiment of the invention a trivariate 3^{rd} order polynomial function has source RGB data for each pixel in the image as inputs and outputs modified RGB data which results in accurate colour appearance for a range of memory colour, whilst displaying saturated colours (those at the edges of the source gamut) at a corresponding position at the edge of the destination gamut, and resulting in a blended intermediate output colour result for colours in between these two regions in the source gamut.

In a further embodiment, the same polynomial function is reconfigured to provide a luminance boost to mid-brightness saturated colours, while maintaining the accuracy according to the source data intent of unsaturated or memory colours, thereby allowing the destination display to be switched to a “vivid” or “dynamic” mode by a simple switch of the operation polynomial parameters.

In a further embodiment, the trivariate polynomial function of any of the previous embodiments may consist of a reduced number of terms, namely the terms of a second order trivariate polynomial, plus the third order term in the product of R, G and B inputs.

In a further embodiment, as the “vivid” mode will result in the effective data value to luminance (“gamma”) curves for the R, G and B channels individually varying according to the data values applied to the other colour channels, a preliminary LUT conversion is applied to the R, G and B data separately to alter the source gamma curves to some intermediate form between the destination target gamma curve for each colour channel while fully saturated (i.e. input value for the other channels are zero), and the destination target gamma curve for each colour channel while fully unsaturated (i.e. R, G and B input values are all equal).

It is also desirable in an embodiment to provide a means of calculating optimal coefficients for the polynomial functions of the previous embodiments which can account for differences in primary colour position, white point, gamma curve shape of the individual R, G and B channels, and variability of primary colour chromaticity with luminance, in the source device and destination device performance, in order to provide the functionality of the primary and subsequent embodiments. In a still further embodiment of this invention, a means of taking a series of colour measurements of the destination display device and using a genetic algorithm or other numerical optimisation tool to find polynomial coefficients which optimally convert the input RGB data of a set of test colours to pre-calculated target output RGB values for those colours collectively is provided.

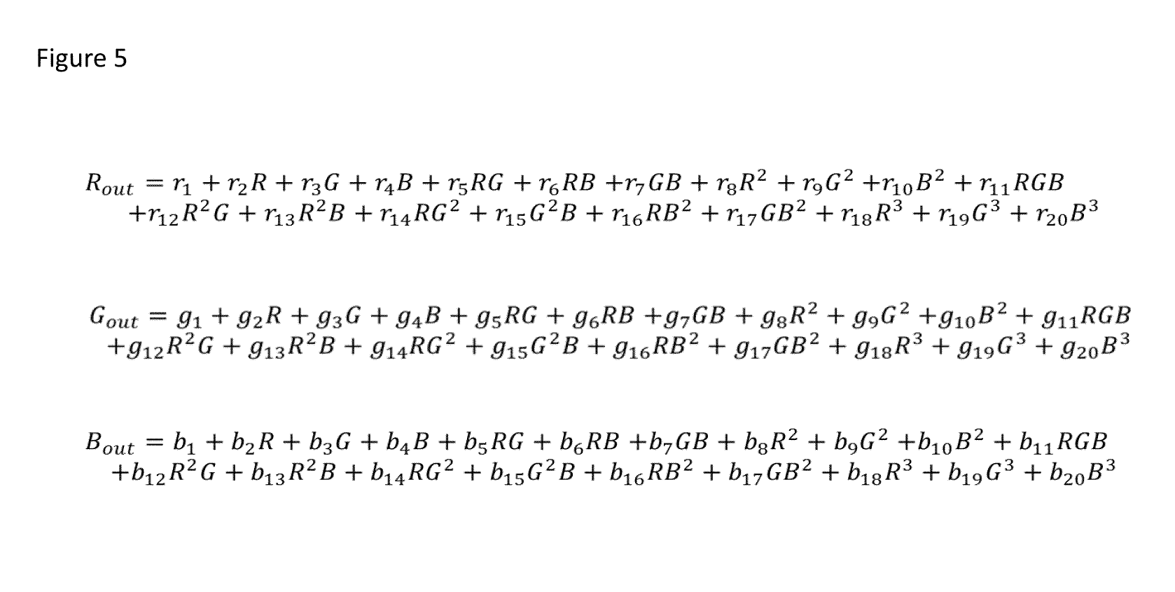

In a principal embodiment of this invention conventional R, G, B colour image data is input on a pixel-by-pixel basis to a trivariate 3^{rd} order polynomial function of the type illustrated in FIG. 5. As shown in the figure, this function takes each RGB data triplet as its inputs, and has a set of coefficients (e.g., r_{1 thru 20}, g_{1 thru 20}, b_{1 thru 20}) to apply to each term of the polynomial for each of the modified data values, Rₒᵤₜ, Gₒᵤₜ and Bₒᵤₜ which it produces as its outputs. The coefficients r, g, b are selected such that the modified Rₒᵤₜ, Gₒᵤₜ and Bₒᵤₜ data values result in accurate colour appearance for a range of memory colours, whilst displaying saturated colours (those at the edges of the source gamut) at a corresponding position at the edge of the destination gamut, and resulting in a blended intermediate output colour result for colours in between these two regions in the source gamut.

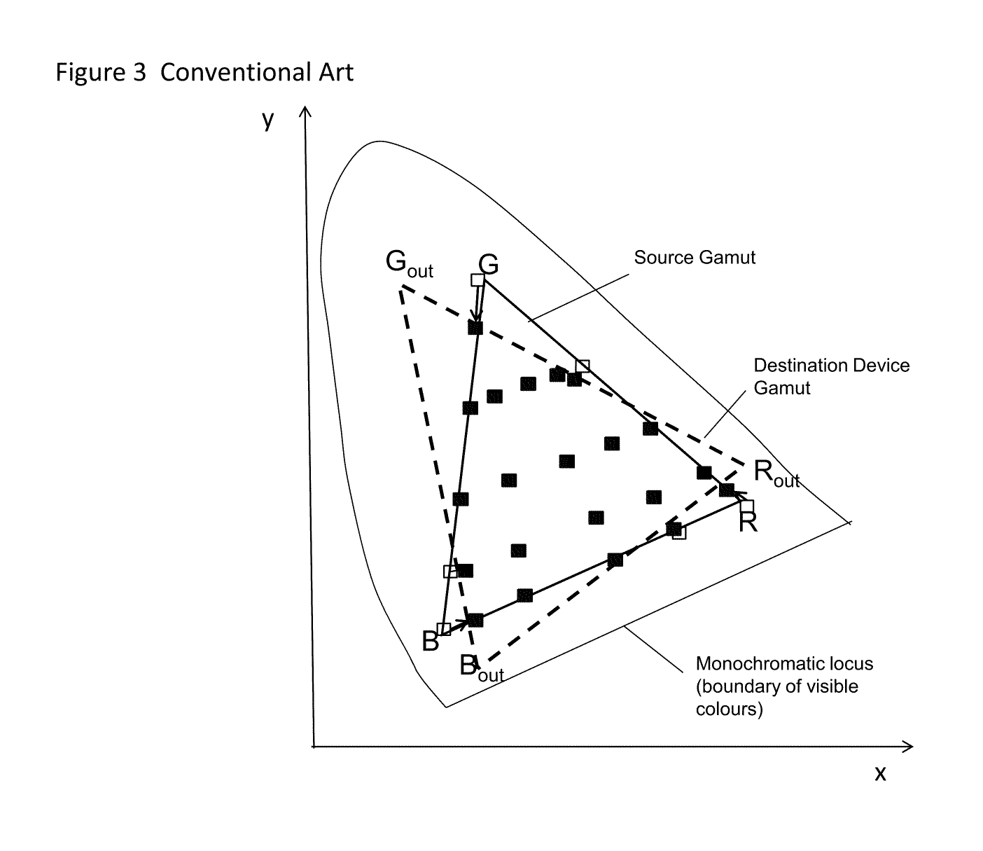

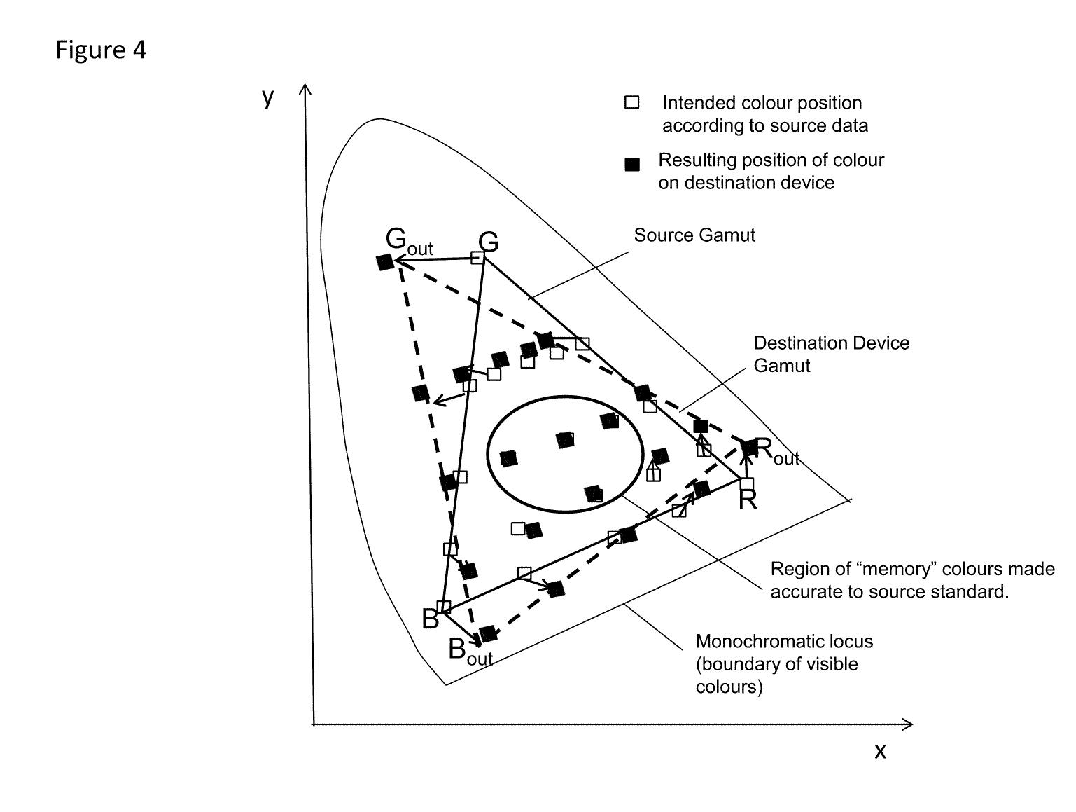

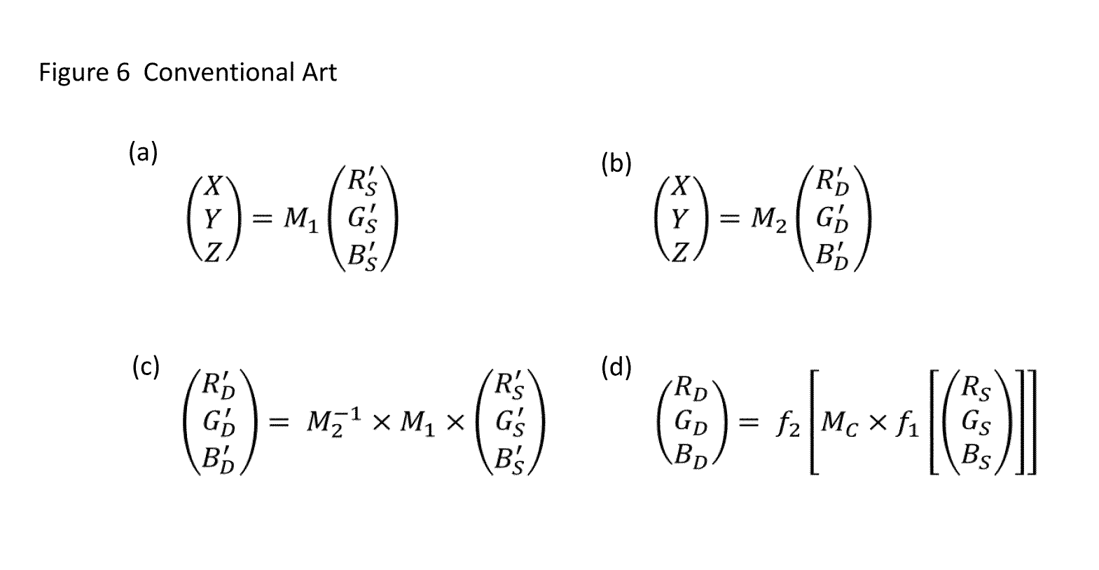

To illustrate this degree of enhanced functionality, it is useful to consider a conventional colour conversion process. The calculation steps of such a process are outlined in FIG. 6. This shows that the image pixel data values of a source data R_{S}, G_{S} and B_{S} may be converted to a device independent colour space such as the CIE XYZ space firstly by converting each of the R_{S}, G_{S} and B_{S} values to have linear luminance increments (“inverse gamma conversion”), either by a LUT or some function f₁. The linearised source data values R_{S}′, G_{S}′ and B_{S}′ may then be pre-multiplied by a transformation matrix M₁ to yield the XYZ values (FIG. 6(a)). The equation of FIG. 6(b) shows that a similar conversion of linearised destination device data values R_{D}′, G_{D}′ and B_{D}′ to the same XYZ space is achieved with a second transformation matrix M₂. If the source and destination data values are to yield the same colour then the XYZ values produced by these transformations will be the same, so the equations of FIGS. 6(a) and (b) may be combined as in FIG. 6(c), to allow direct calculation of the linearised destination RGB values which will produce an identical colour to any linearised source data values. A complete gamut mapping process then may look as shown in FIG. 6(d), whereby a function f₂ is used to apply a gamma function to the linearised destination data values, the transformation matrix M_{C} is the pre-multiplied result of the inverse of M₁ on M₂, and f₁ applies the inverse gamma function to linearise the non-linear source data values. With clipping to eliminate any out-of-gamut destination values which may result, this process would allow the colour space conversion as illustrated in FIG. 3, where all input source data values are mapped to output destination data values which produce an identical colour in the gamut regions where the source and destination gamuts overlap.

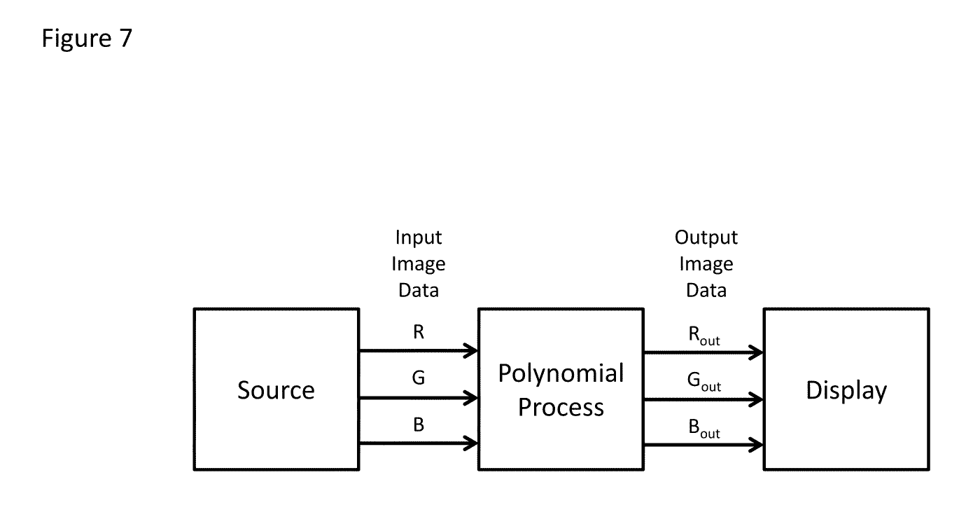

It is clear that a polynomial process consisting of only the terms with coefficients r₂ to r₄, g₂ to g₄ and b₂ to b₄ equal to the elements of the matrix M_{C} would be sufficient to provide the function of the above described conventional transform, if combined with the gamma and inverse gamma functions f₁ and f₂ and output clipping. However, if the effect of the functions f₁ and f₂ can be approximated by using some or all of the remaining polynomial terms, possibly in combination with modified values for the coefficients already considered, this may allow an advantageous implantation as the processing for functions f₁ and f₂ will not need to be implemented. Further advantage may be gained by also using all the polynomial terms in combination to produce the effect of a more complex perceptual mapping for the out-of-gamut colours and a blending effect between a memory colour region and a saturated colour or otherwise defined colour region. In this case, the full functionality of a more complex perceptual gamut mapping algorithm may be achieved using the simplified process flow illustrated in FIG. 7, by careful selection of the polynomial coefficients.

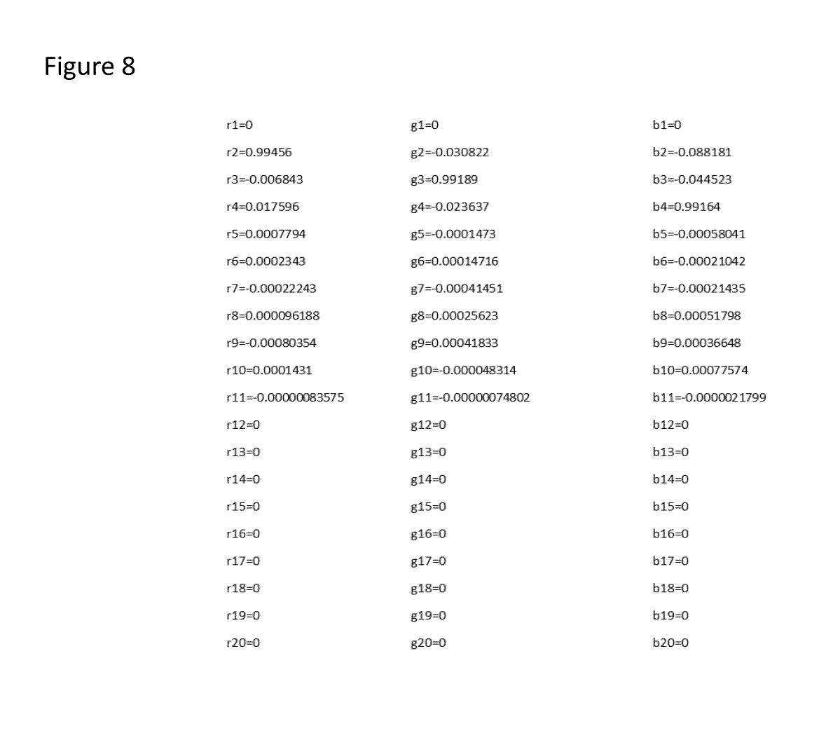

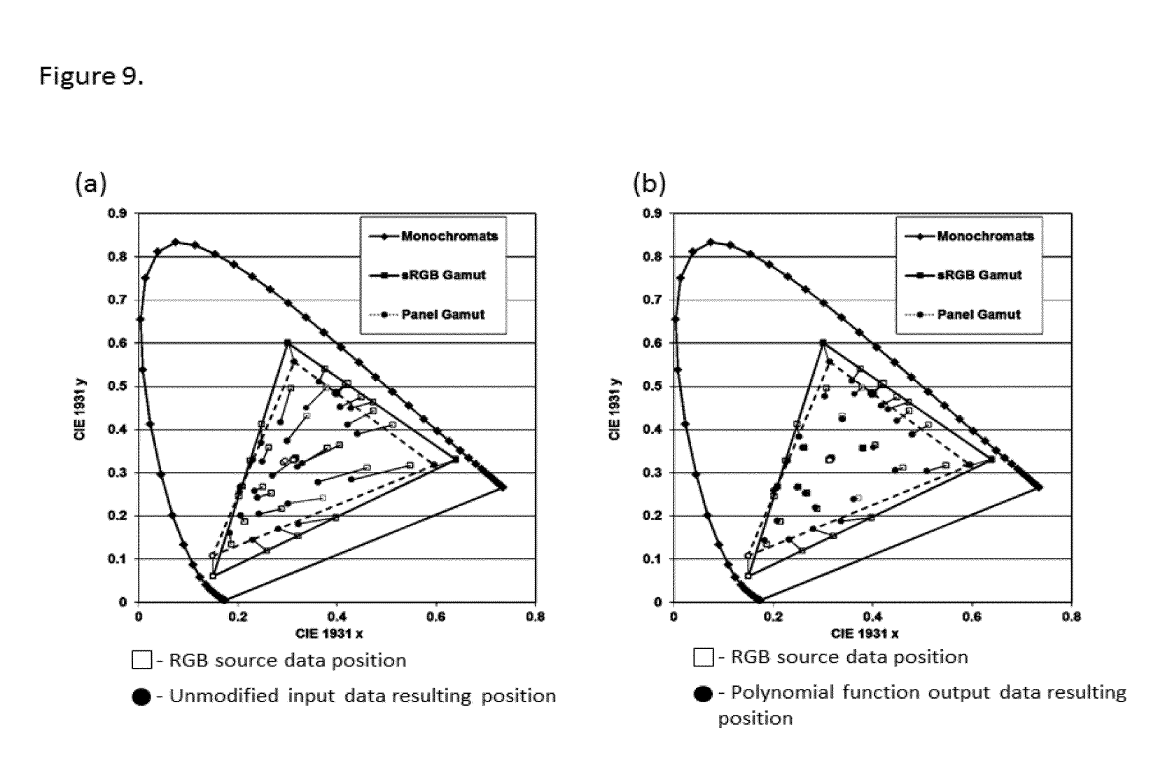

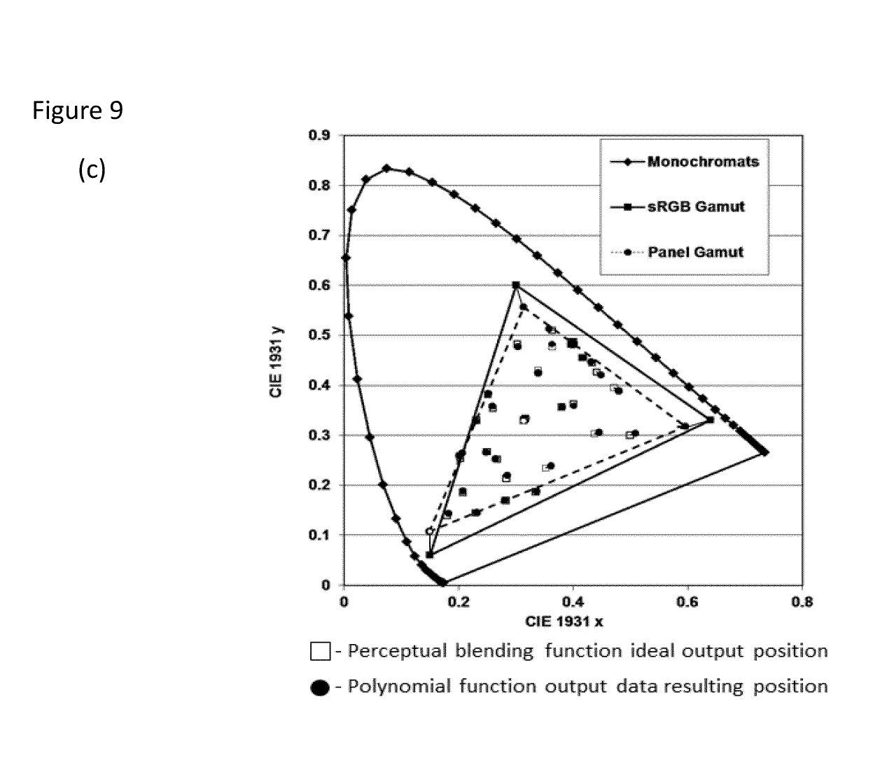

FIG. 8, shows example polynomial coefficients for optimal conversion of source data specified according to the sRGB standard, to output data for display on a non-standard display. FIG. 9(a) shows the non-standard display gamut on a CIE xy diagram along with the sRGB gamut. The figure also shows a set of sample colour positions, with their sRGB source data intention position in the CIE xy space (hollow squares), and the resulting position when input to the non-standard display (solid circles). It can be seen from the figure that in addition to the display gamut area being smaller than the sRGB gamut area, and the R, G and B primary colours of the display being incorrectly positioned, the white balance of the display is incorrect, the blue primary having excessive luminance causing most input colours to be displayed with a colour position too close to the blue primary position. FIG. 9(b) shows the CIE xy position of the same set of test colours after modification according to the polynomial process using the parameters of FIG. 8. It can be seen from the figure that unsaturated sample colours near the centre of the gamut area are corrected to match the source intention very closely, while the saturated sample colours transferred from the boundary of the sRGB gamut to a corresponding position on the boundary of the non-standard display gamut. FIG. 9(c) shows the CIE xy position of the same set of sample colours on the non-standard display, after modification be the polynomial process (solid circles), with their ideal target position according to a blended perceptual gamut mapping algorithm (hollow squares). It can be seen that for the sample colours a close match between the output result on the non-standard display and the pre-calculated ideal target result is achieved.

This shows that the polynomial function is able to account for all the destination display colour inaccuracies listed above, and produce a close match to a perceptually optimised gamut transform calculated output colour value for all colours, without any conversion to an intermediate device independent colour space, or complex matrix based or blending calculation required.

A standard measure of the difference between the ideal target and resulting colour for each sample input may be calculated using the CIE ΔE₂₀₀₀ colour difference measure, and for the example non-standard display the average ΔE₂₀₀₀ value for the difference between the ideal target and the result is improved from 7.98 to 1.29 by the application of the polynomial function, for a test set of over 700 sample input colours.

It is worth noting that the ideal target, and resulting output, CIE 1931 xy positions for some of the sample colours in FIG. 9 are outside the triangular boundary of the non-standard panel gamut. This is due to the fact that the panel gamut as shown in the figure is defined by the position of the three display primaries at maximum brightness. On the non-standard panel, the CIE 1931 xy position of the primary colours has been shown to vary with luminance, so for some mid-brightness input colours, a greater degree of saturation may be achieved than for maximum brightness inputs. It can be seen from the figure that the polynomial process is able to account for this primary colour position variation, both in maintaining optimum accuracy to the target colour position for mid-brightness input colours, and allowing for a closer match to the source intention saturation for mid-brightness colours where possible.

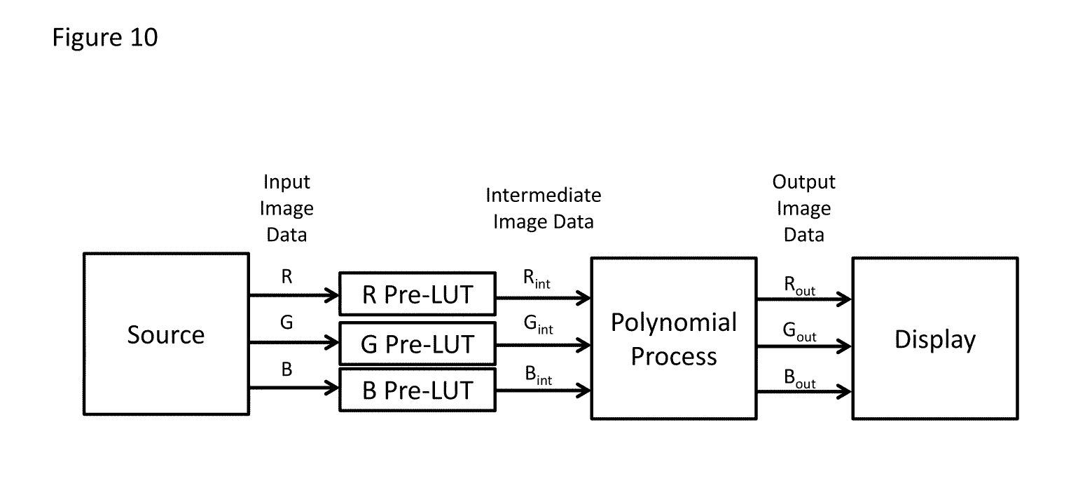

In a further embodiment of this invention conventional R, G, B colour image data is input on a pixel-by-pixel basis to a one-dimensional lookup table (LUT) for converting the R, G and B input data separately to an intermediate data level, which is then input to the trivariate 3^{rd} order polynomial function of the type described in the principal embodiment. This process incorporating a “Pre-LUT” conversion is illustrated in FIG. 10.

One advantage of the inclusion of the Pre-LUT function is it allows the gamma curve for the R, G and B data channels to be modified prior to input to the polynomial process. One particular use for this modification may be to allow gamma curves of intermediate shape to be produced, when the desired output shape for the gamma curve of a particular channel is different to the desired output shape of the gamma curve for grey input colours (i.e. R, G and B data levels are all equal). This may be the case if the display is required to operate in a mode designed to boost the perceived vividness of images by applying a luminance boost to input colours which are saturated (e.g. mid brightness primary colours), while maintaining the standard luminance of unsaturated colours (e.g. greys).

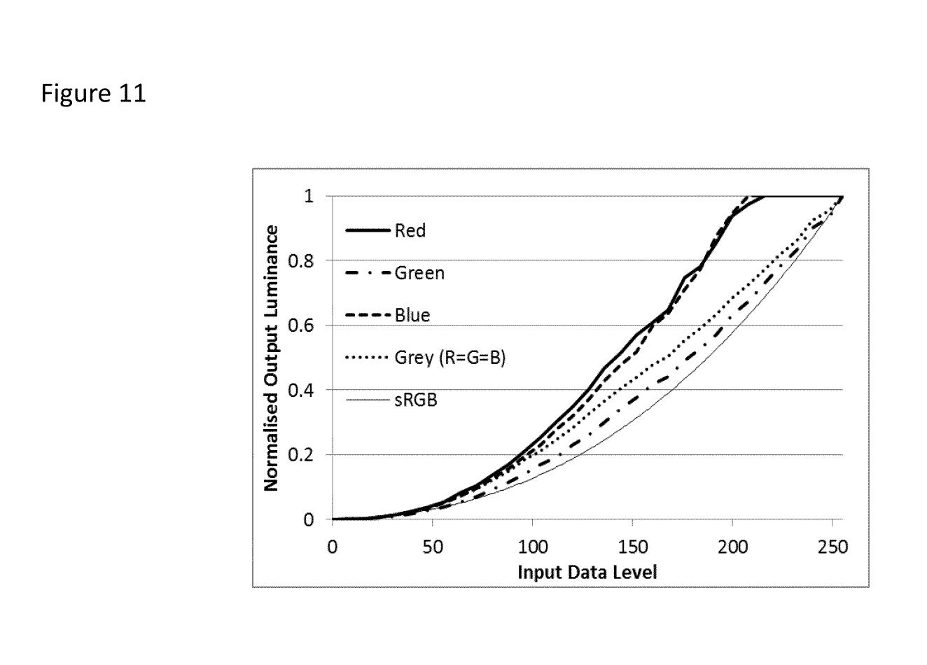

FIG. 11 shows the data value to luminance (gamma) curves of the R, G and B channels separately, and the gamma curve of grey data inputs (R=G=B), each normalised to their respective maxima, measured on a television panel operating in the user selectable “Dynamic” colour mode. It can be seen that when only the green data level is greater than zero, the green channel's gamma curve follows the well-known power law shape, the luminance being approximately proportional to the data value divided by 255 and raised to the power γ=2.2, similar to that specified in the sRGB standard. When the input data RGB values are all equal, the gamma curve also follows a power law shape, but with a slightly smaller exponent (γ≈2.0) However, when only the R or only the B channel is greater than zero, the resulting gamma curve exhibits an increased resulting luminance for mid-valued data levels, and the output luminance saturates at an input data level significantly lower than the maximum of 255.

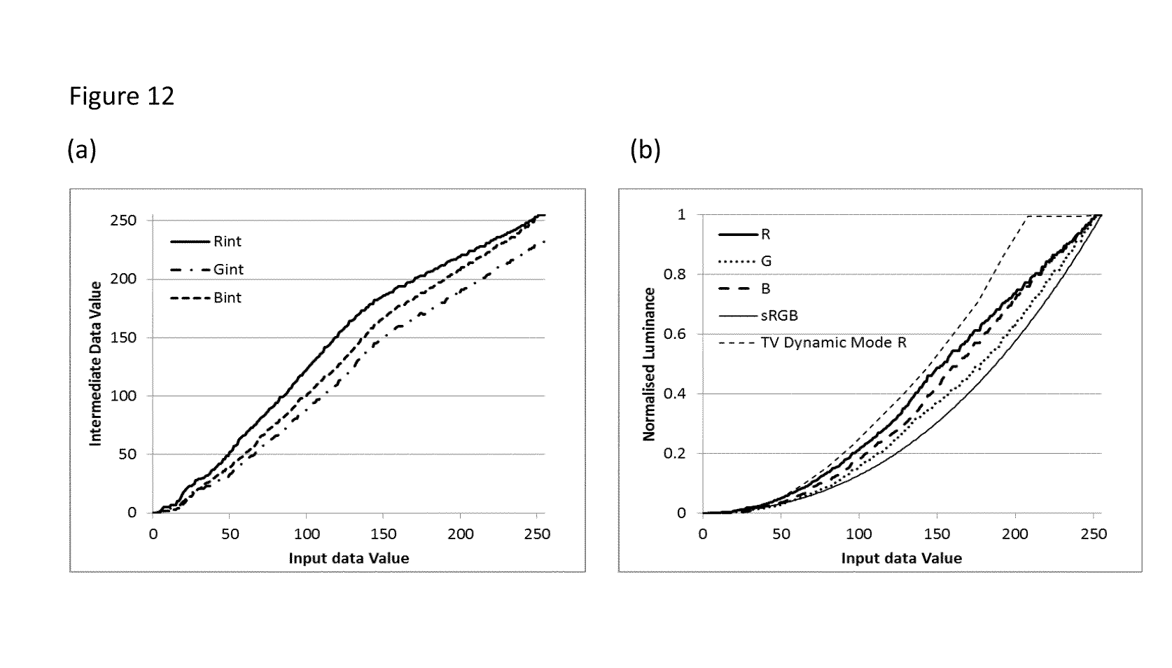

When the display of this embodiment is required to operate in a mode approximating this type of colour performance, it may be advantageous to use the Pre-LUT function to produce intermediate R, G and B data values having a resulting luminance which is mid-way between the resulting luminance for that data value when the other colour channel has a data value of zero, and the resulting luminance produced by that channel when the other channels have a matching input data value. An example of such a Pre-LUT calculated for the same non-standard display used in the previous example (FIG. 9) is illustrated in FIG. 12. FIG. 12 (a) shows a plot of the input vs. output data values of the Pre-LUT, and FIG. 12 (b) shows the resulting luminance of the Pre-LUT processed input values produced by the display. It can be seen that for the R and B channel, the luminance of the mid-level values is increased to lie between the sRGB and TV “Dynamic mode” prescribed values. As the sRGB and TV “Dynamic mode” prescribed values for the G channel and grey values are not so different, the luminance result of the Pre-LUT processed values is more similar to the sRGB prescribed result.

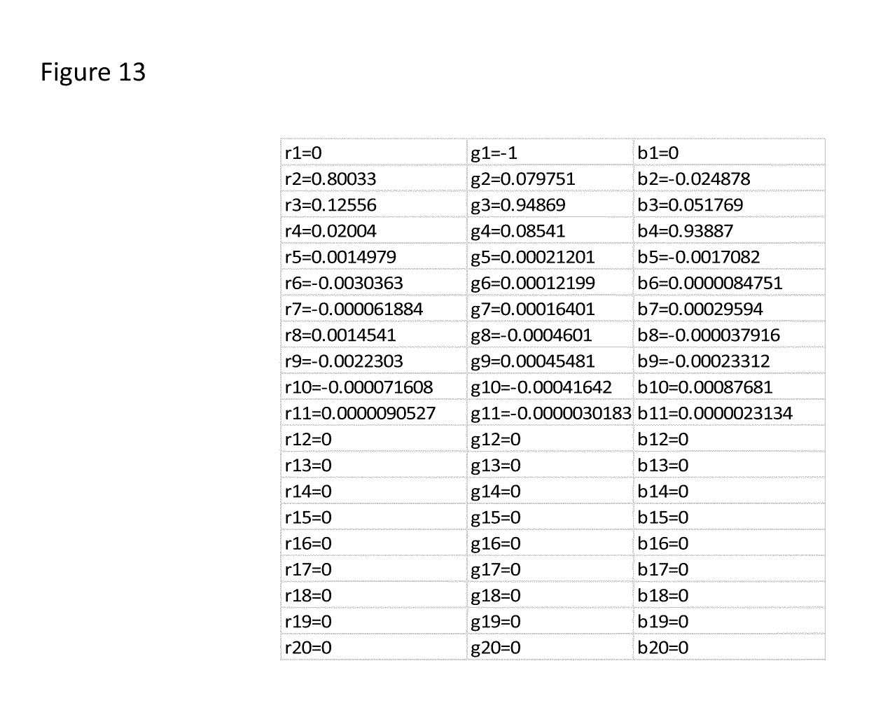

FIG. 13 shows example polynomial coefficients which, when used in conjunction with the Pre-LUT of FIG. 12 results in colour performance on the same non-standard panel of previous example which closely replicates the colour performance of the measured television panel in “dynamic mode”.

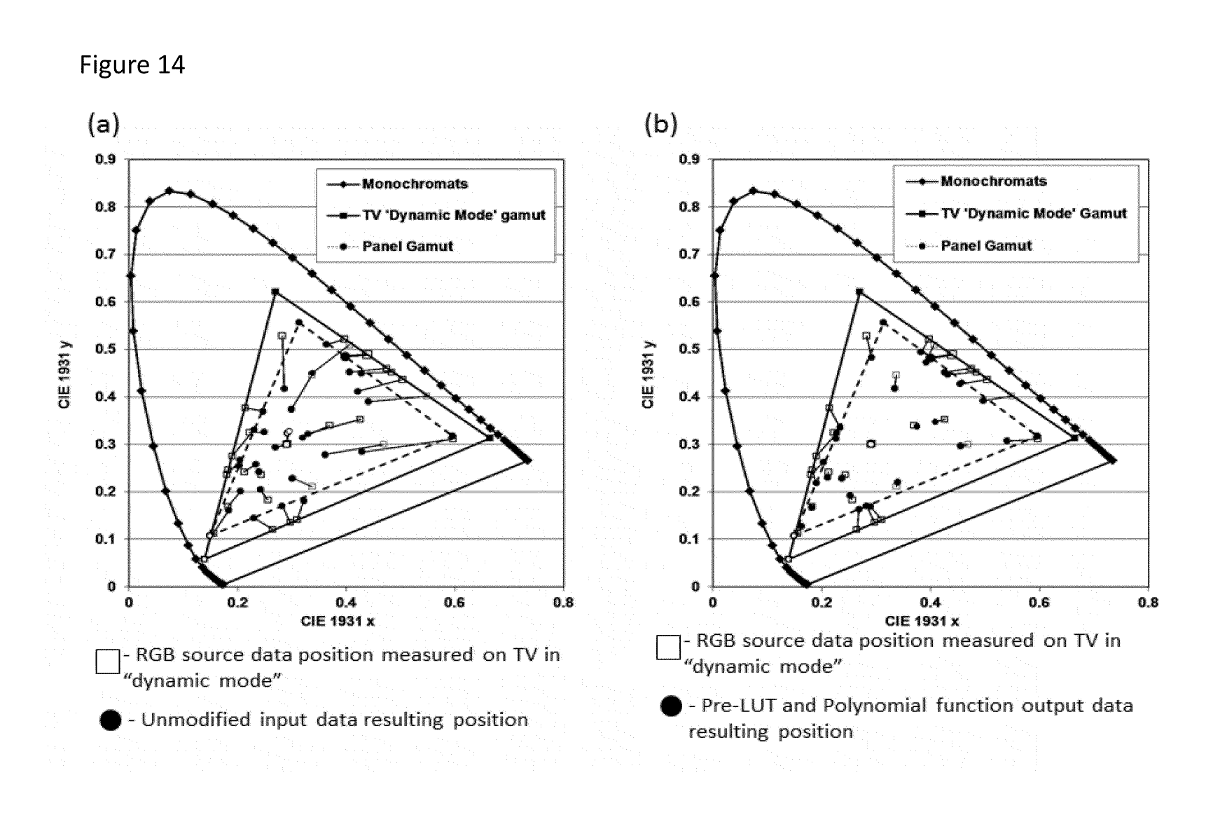

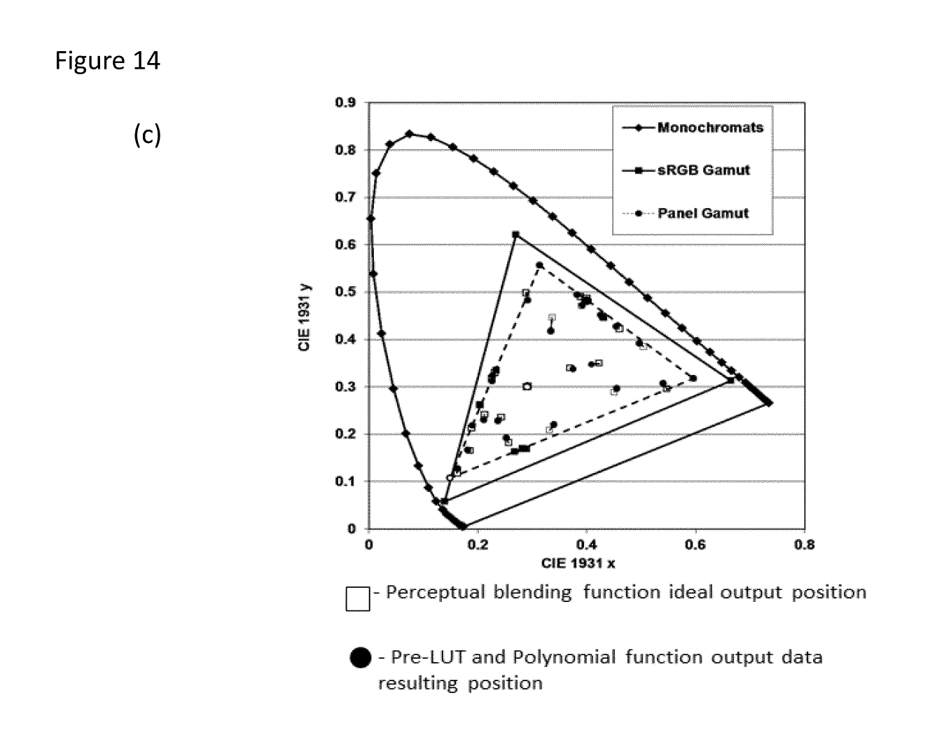

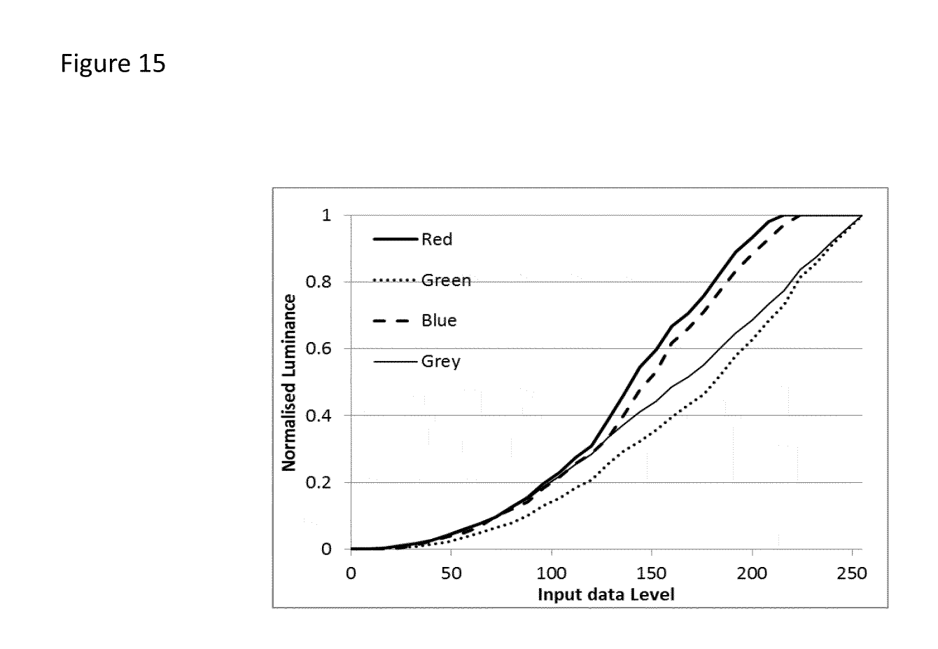

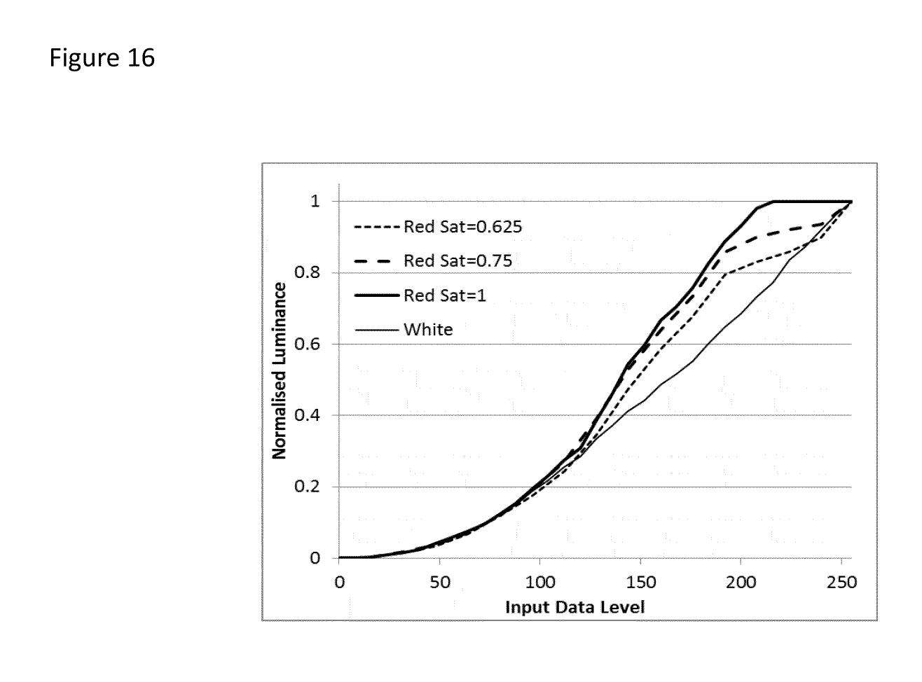

FIG. 14(a) shows the CIE 1931 xy plot with a set of sample colour positions, with their measured position on the TV in “dynamic mode” (hollow squares), and the resulting position when input to the non-standard display (solid circles). It can be seen that largely due to the significantly smaller gamut area of the non-standard display panel, the majority of the sample colours are displayed with too low a saturation (too close to the centre of the gamut area) relative to the source intention. FIG. 14(b) shows this same data after processing with the Pre-LUT of FIG. 12 and polynomial using the parameters of FIG. 13. It can be seen that the unsaturated sample colours near the centre of the gamut area are corrected to match the position of the same colours measured for the TV in “dynamic mode” very closely, while the saturated sample colours are transferred from the boundary of the TV gamut to a corresponding position on the boundary of the non-standard display gamut. FIG. 14(c) shows the CIE xy position of the same set of sample colours on the non-standard display, after modification by the polynomial process (solid circles), with their ideal target position according to a blended perceptual gamut mapping algorithm (hollow squares). It can be seen that for the sample colours a close match between the output result on the non-standard display and the pre-calculated ideal target result is achieved. In this example, the average ΔE₂₀₀₀ value for the difference between the ideal target and the result from the combined Pre-LUT and polynomial process is improved from 7.4 to 0.94, for a test set of over 450 sample input colours. It can also be seen that the ideal target position of the sample colours is generally closer to the panel gamut boundary, and therefore more saturated, in this configuration in which the target colour performance is the TV “dynamic mode”, compared to the results of FIG. 9 in which the target position is determined by the sRGB standard. This indicates the intended effect of a “vividness boost” to the resulting image appearance is achieved. This is confirmed by examination for the resulting gamma curves or R, G, B and grey data input to the process. These resulting curves are shown in FIG. 15 and can be seen to be a close match to the equivalent curves as measured on the TV in dynamic mode in FIG. 11. In additional the effect of a smooth blend between the luminance boost applied to mid brightness saturated colours, and the absence of an equivalent boost to unsaturated colours is illustrated by FIG. 16, which shows the normalised luminance against maximum data value for red colours of differing saturation. It can be seen that the increase in mid-level luminance increases with saturation.

These results shows that the polynomial function in conjunction with the Pre-LUT is able to account for all the destination display colour inaccuracies previously listed, and produce a close match to a perceptually optimised gamut transform calculated output colour value for all colours, even when that transform includes a saturation dependent luminance boost for selected colours, without any conversion to an intermediate device independent colour space, or complex matrix based or blending calculation required.

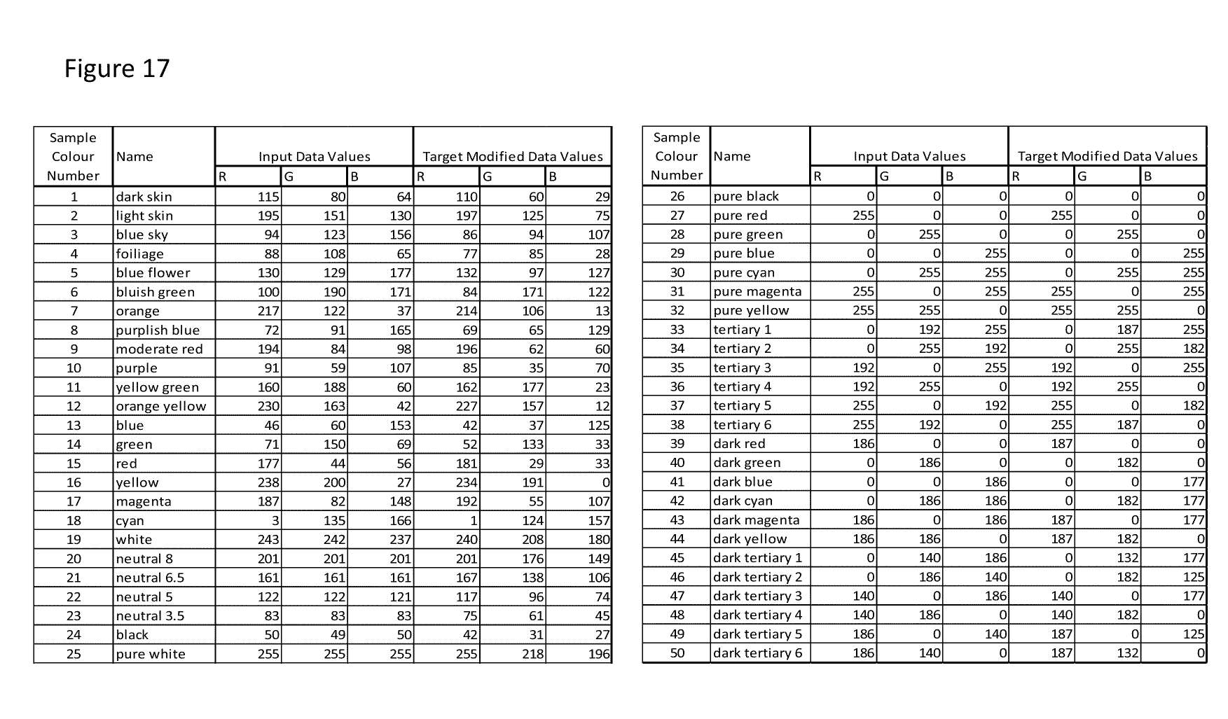

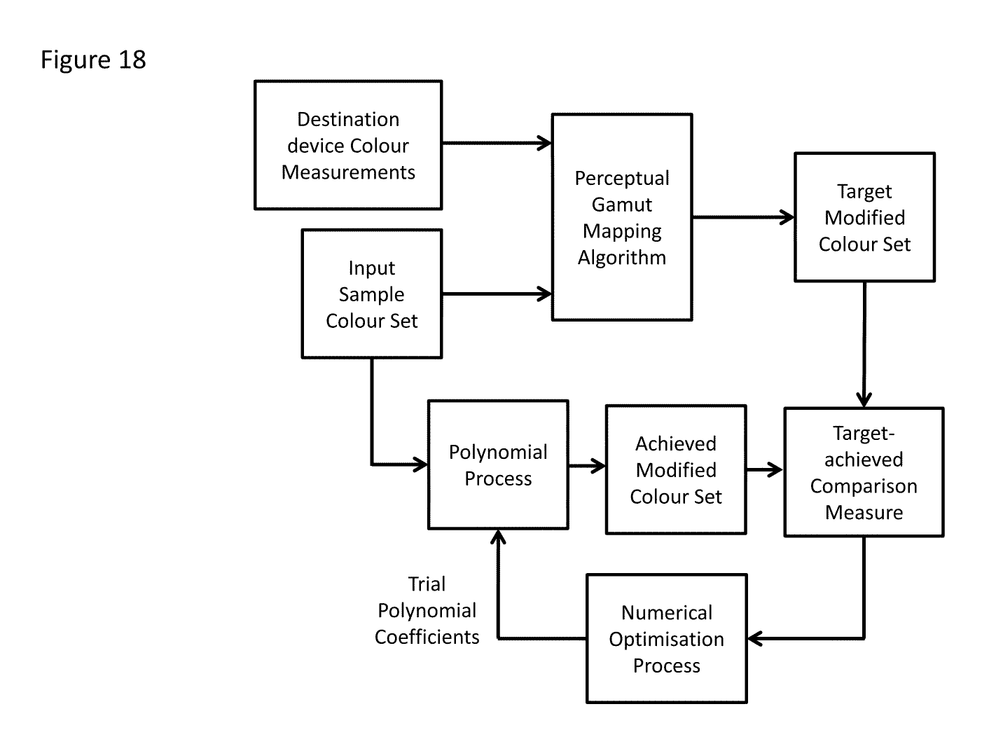

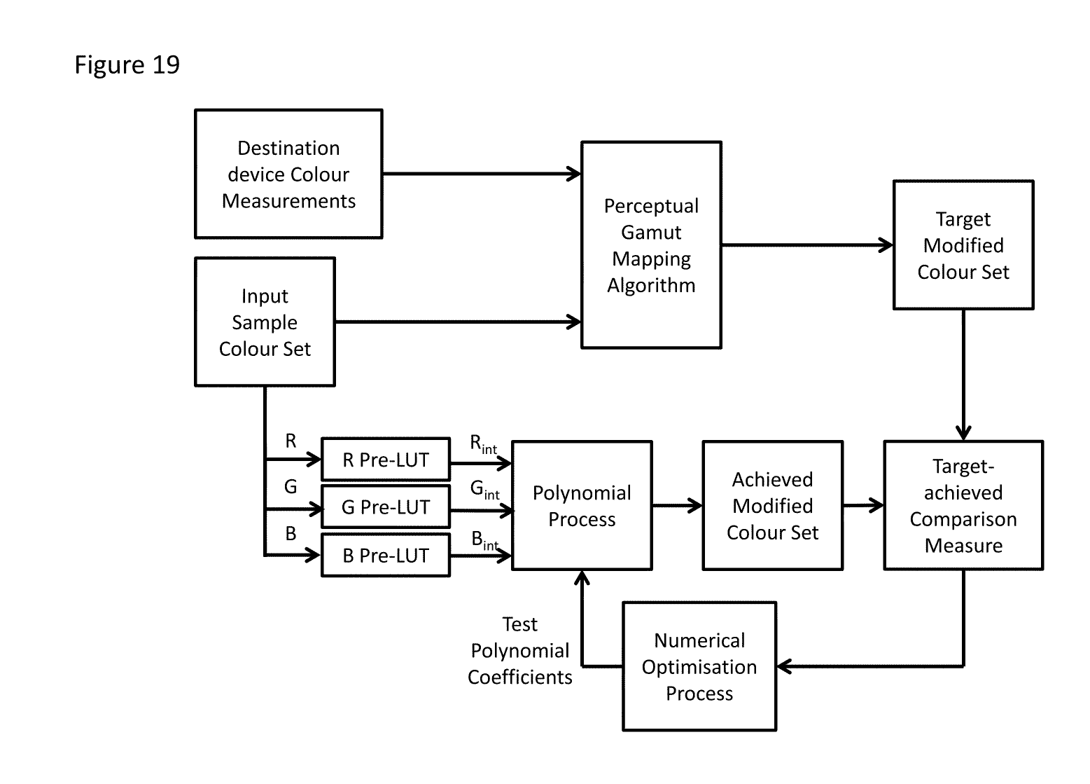

In a still further embodiment, a means of calculating optimised polynomial coefficients is provided. For any given set of sample test colours (RGB data combinations) a corresponding set of modified RGB data values may be found or calculated which, when input to the destination device, result in a colour appearance which for each sample colour is as close as possible to a perceptually optimised transform of the source intention of that sample colour to the destination device gamut. This then provides a set of sample colour RGB combinations and a corresponding set of ideal target RGB combinations. An example set of 50 sample colours and target modified colours, including the Gretag-Macbeth chart colour values, for conversion of sRGB intention input colours for display on the non-standard display of previous examples (the conversion shown in FIG. 9) is shown in FIG. 17. Once the list of sample input and target modified colours has been produced, coefficients for the polynomial process may be found or calculated which produce as closely as possible the transformation from the input sample RGB combinations to the target modified RGB combinations, for all the sample colours used. This process of calculating target RGB combinations for each of a set of input sample RGB combinations using a perceptual gamut mapping algorithm, and then using a numerical optimisation process carried out by computer processor to produce polynomial coefficients which minimise the difference in the target modified RGB data set and the achieved modified RGB data set, is shown in FIG. 18. A similar process in which a Pre-LUT step as described previously is used in conjunction with the polynomial process is illustrated in FIG. 19.

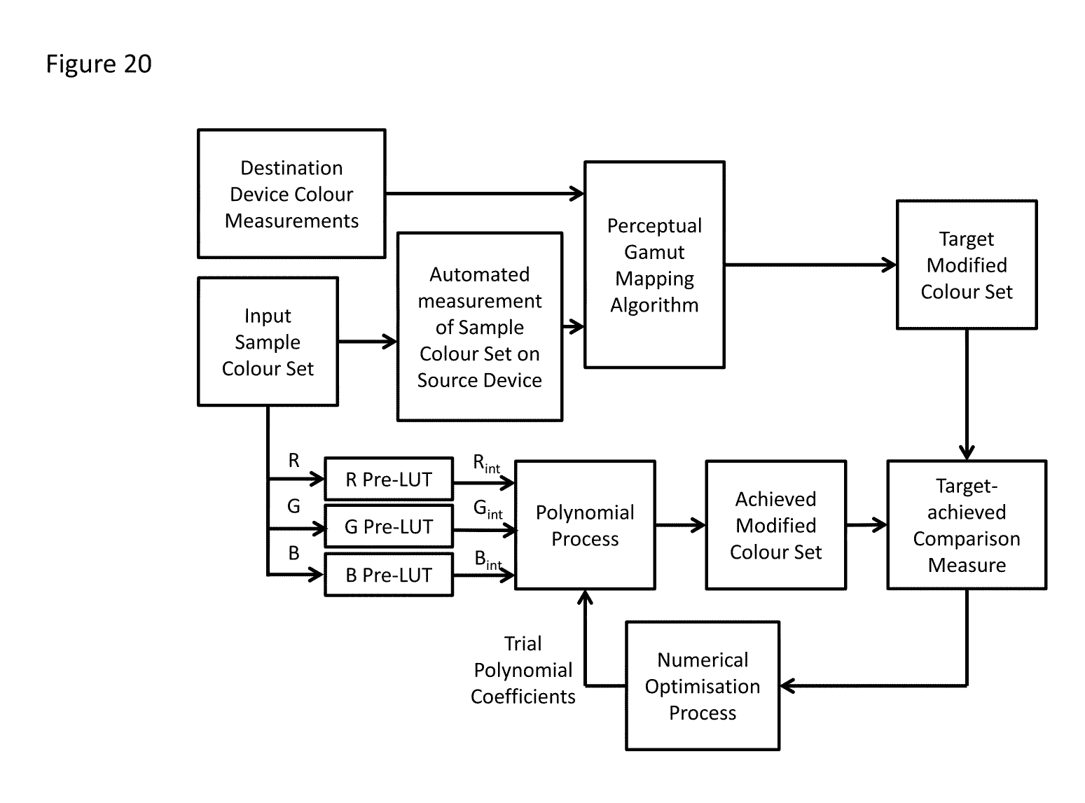

The process for calculating the target modified RGB data combination for each input sample combination may first calculate the CIE XYZ and/or L*a*b* values for each sample colour according to the source intention. The source intention may be a colour standard such as sRGB in which case the calculation to find intended XYZ values from the RGB data values is well known, or it may be an existing colour performances on a known display, in which case the XYZ values produced by each sample colour on the source display may be measured by displaying the sample colour on the source display and measuring the XYZ and/or L*a*b values with a calibrated colorimeter. The process flow in this case is illustrated in FIG. 20.

Having obtained or calculated the source data intention for each of the sample RGB combinations, the process may then search for or calculate target modified RGB data values for each of the input sample colours which when input to the source display produce CIE XYZ or L*a*b* values giving as close as possible a match to the source intention XYZ or L*a*b* values of each sample colour. The modified RGB values may be those that produce the smallest absolute difference in XYZ values, or the minimum ΔE₂₀₀₀ colour difference measure.

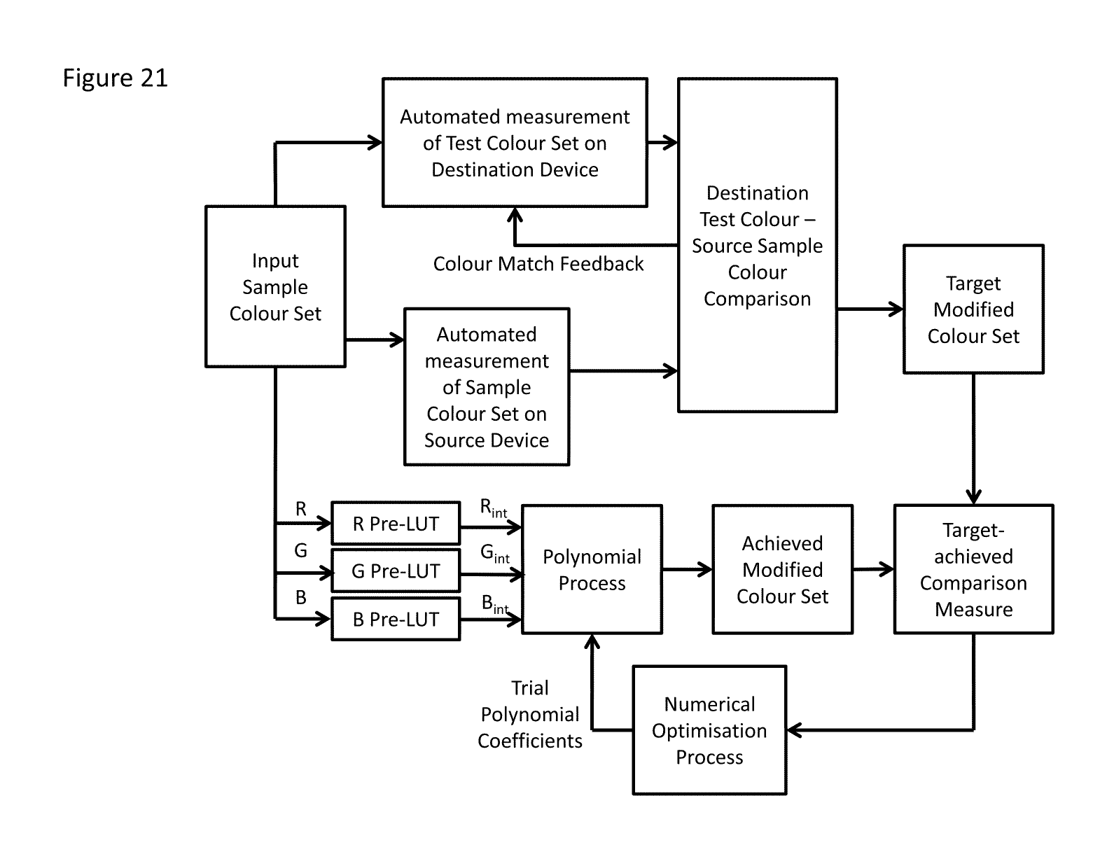

These target modified RGB data values may be calculated using a set of colour measurements of the destination device which may then be used to predict the resulting XYZ and/or L*a*b values of other colours, or they may be found using an automated measurement system with a feedback or trial-and-error method to sequentially display a test colour on the destination device and measure the XYZ or l*a*b values which result in order to find the modified RGB values which give the optimal match to the source intention. This potential process is illustrated in FIG. 21.

The optimal polynomial coefficients for converting the input sample colour RGB data values into the modified target RGB data values for all the sample colours simultaneously may be produced via a numerical solving algorithm (a numerical solver) implemented by a computer processor and aimed at minimising the sum of differences between the target modified RGB data values and the achieved modified RGB data values produced by the polynomial process. The numerical solver may be aimed at minimising the sum of the square of these differences, or some weighted sum of the differences and their squares, or any other suitable predefined criteria. The numerical solver may be of the evolutionary or genetic algorithm type. The numerical solver may solve for optimum parameters for each colour channel separately (e.g. find optimum values for coefficients r₁ to r₂₀, then for g₁ to g₂₀, then for b₁ to b₂₀), or it may solve them all simultaneously. It may use a calculation based on the CIE XYZ or L*a*b* for each tested modified set of RGB data values achieved by the polynomial to find a colour difference measure, and solve to minimise the colour differences between the target modified RGB data values and the achieved RGB data values.

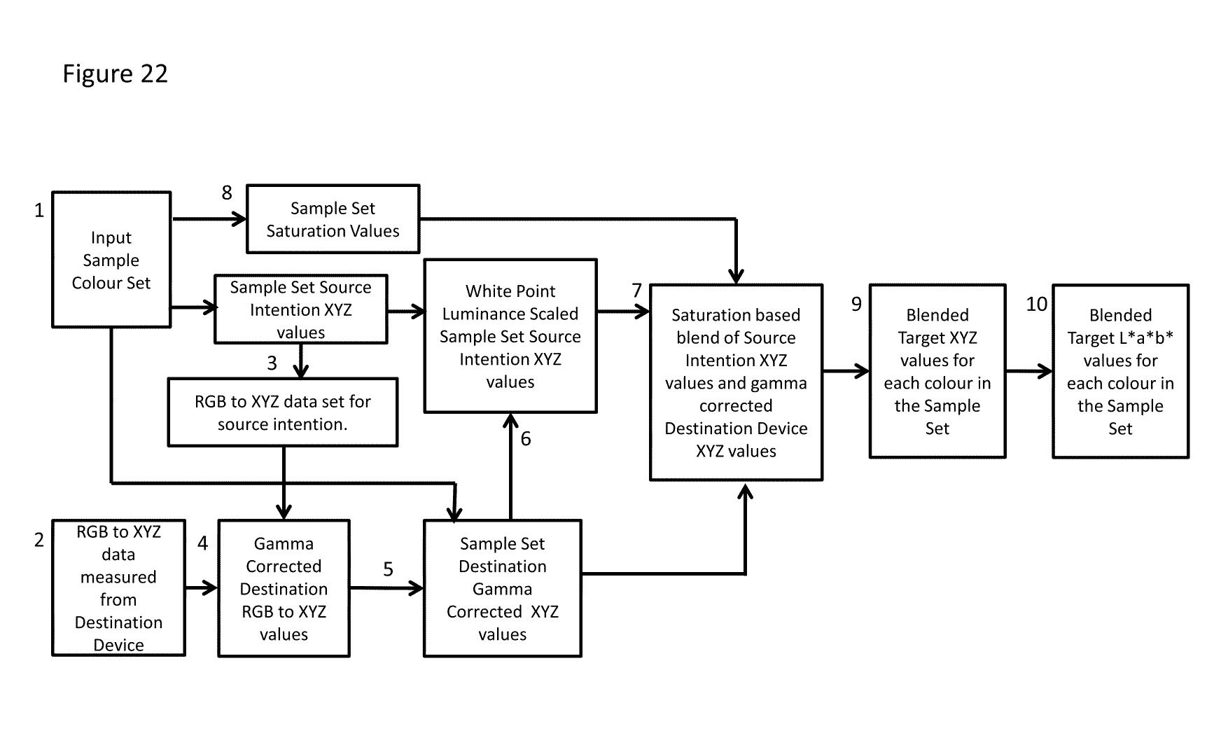

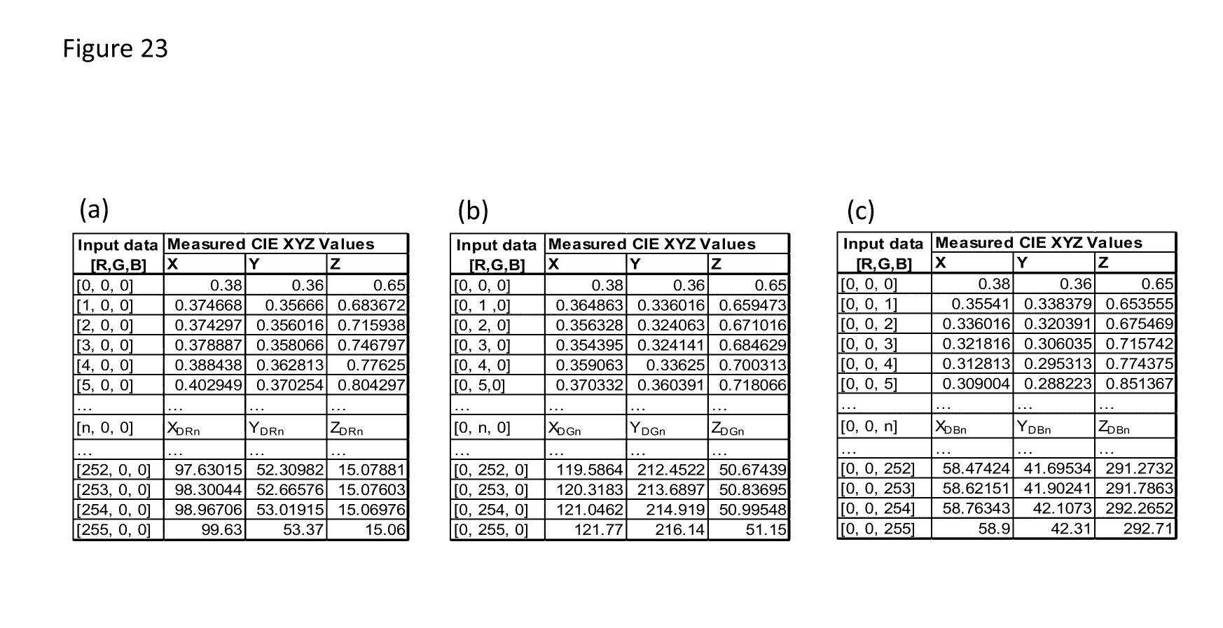

In an exemplary implementation of this embodiment, the process of which is illustrated in FIGS. 22 to 24, and the steps of which are annotated with numerals below indicated on those figures, between 200 and 1000 RGB combinations are used in the input sample colour set (1). Additionally, the CIE XYZ values produced by the destination display for inputs of R, G and B only (i.e. R, while G and B equal 0, G while R and B equal zero and B while R and G equal zero) from 0 to 255 in steps of between 1 and 32 are measured using a colorimeter. If the increment of the input data value is greater than 1, the remaining values may be interpolated from the measured ones to produce a complete set of destination RGB to XYZ data values (2). A truncated set of such RGB to XYZ data values, as measured on the non-standard display of previous embodiments, is shown for illustration in FIG. 23. In the notation of this figure, X_{DRn} denotes the CIE 1931 X value produced by the Destination device from a pure Red input of data n. Similarly Y_{DGn} denotes the CIE 1931 Y value produced by the Destination device from a pure Green input of data n.

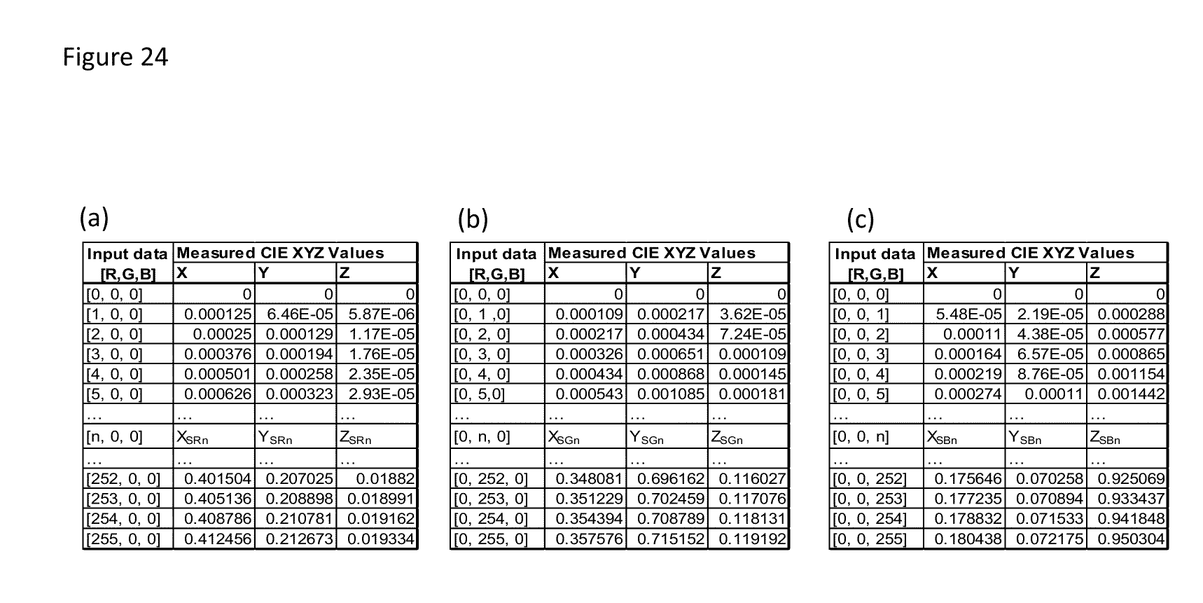

Included in the input sample colour set (1) are test colours corresponding to those used to produce the destination device RGB to XYZ data set, allowing a corresponding source RGB to XYZ data set (3) to be calculated. An example set of source RGB to XYZ data tables are shown in FIG. 24, with values calculated according to sRGB standard source data. These data sets enable prediction of the CIE XYZ values of any RGB input on the destination display, by summation of the XYZ values produced by each of R, G and B separately. For example, an RGB input of [a,b,c] is predicted to produce XYZ values of

X_{[a,b,c]}=X_{DRa}+X_{DGb}+X_{DSc} Eqn 1a

Y_{[a,b,c]}=Y_{DRa}+Y_{DGb}+Y_{DBc} Eqn 1b

Z_{[a,b,c]}=Z_{DRa}+Z_{DGb}+Z_{DGc} Eqn 1c

In the next step (4) the RGB to XYZ data values are “gamma corrected” so as to match the data value to luminance curves of the source intention. As the CIE 1931 Y value corresponds to luminance, this may be achieved with the following calculations applied to all values of n:

$$\begin{matrix}{X}_{DRn}^{′} = {X}_{DR 255} \times ( \frac{{Y}_{SRn}}{{Y}_{SR 255}} ) , \\ {Y}_{DRn}^{′} = {Y}_{DR 255} \times ( \frac{{Y}_{SRn}}{{Y}_{SR 255}} ) , \\ {Z}_{DRn}^{′} = {Z}_{DR 255} \times ( \frac{{Y}_{SRn}}{{Y}_{SR 255}} ) , & Eqns 2 a \\ {X}_{DGn}^{′} = {X}_{DG 255} \times ( \frac{{Y}_{SGn}}{{Y}_{SG 255}} ) , \\ {Y}_{DGn}^{′} = {Y}_{DG255} \times ( \frac{{Y}_{SGn}}{{Y}_{SG 255}} ) , \\ {Z}_{DGn}^{′} = {Z}_{DG 255} \times ( \frac{{Y}_{SGn}}{{Y}_{SG 255}} ) , & Eqns 2 b \\ {X}_{DBn}^{′} = {X}_{DB 255} \times ( \frac{{Y}_{SBn}}{{Y}_{SB 255}} ) , \\ {Y}_{DBn}^{′} = {Y}_{DB 255} \times ( \frac{{Y}_{SBn}}{{Y}_{SB 255}} ) , \\ {Z}_{DBn}^{′} = {Z}_{DB 255} \times ( \frac{{Y}_{SBn}}{{Y}_{SB 255}} ) , & Eqns 2 c\end{matrix}$$

These gamma corrected destination RGB to XYZ data values (4) are then used to calculate gamma corrected destination XYZ values for all the RGB combinations in the sample set (5)

The gamma corrected destination RGB to XYZ data values (4) are then used to find the highest luminance value with a CIE xy values within a given difference of the CIE_xy values of the source white point. The CIE xy position of the source white point is given by:

$$\begin{matrix}{x}_{S [ 255 , 255 , 255 ]} = \frac{{X}_{S [ 255 , 255 , 255 ]}}{( {X}_{S [ 255 , 255 , 255 ]} + {Y}_{S [ 255 , 255 , 255 ]} + {Z}_{S [ 255 , 255 , 255 ]} )} & Eqn 3 a \\ {y}_{S [ 255 , 255 , 255 ]} = \frac{{Y}_{S [ 255 , 255 , 255 ]}}{( {X}_{S [ 255 , 255 , 255 ]} + {Y}_{S [ 255 , 255 , 255 ]} + {Z}_{S [ 255 , 255 , 255 ]} )} & Eqn 3 b\end{matrix}$$

and the CIE xy position of any RGB input on the destination device may be found using equivalent equations for the destination RGB to XYZ data (2). In this example, the highest luminance result for an RGB combination input to the destination device with CIE 1931 xy values matching the source white point xy values to within +/−0.0005 is found. This maximum possible luminance value of the destination display at the source white point is then used to scale source intention sample set XYZ values by multiplying all values in this data set by the ratio of the maximum possible luminance value of the destination display to the source white point luminance. This produces the luminance scaled source intention XYZ sample data set (6).

In the next step (7) the sample set destination gamma corrected XYZ values (5) are blended with the white point luminance scaled sample set source intention XYZ values (6) according to the saturation of each colour in the sample set. This is calculated according to the RGB values of each colour in the sample set as:

$$S = \frac{max ( RGB ) - min ( RGB )}{Max ( RGB )} \qquad Eqn 4 a$$

Which gives a value between 0 and 1. In order to ensure that a greater selection of colours then only pure grey colours are attributed a saturation value of 0, and therefore are produce a target XYZ value from the blending process matching the source intention XYZ value, this saturation measure may be modified according the equation:

S′=max(0,S*(1+f)−f) Eqn 4b

Where f is a factor between 0 and 1, typically 0.7, which determines the proportion of RGB values which are attributed a saturation of 0, while still maintaining a smooth blend in saturation values from 0 to 1. Each RGB combination in the sample set then has its blended target XYZ value calculated according to the equations:

X_{BlendedTarget}=S′×X_{GammaCorrectedDestination}+(1−s)X_{LuminanceScaledSource} Eqn 5a

Y_{BlendedTarget}=S′×Y_{GammaCorrectedDestination}+(1−s)Y_{LuminanceScaledSource} Eqn 5b

Z_{BlendedTarget}=S′×Z_{GammaCorrectedDestination}+(1−s)Z_{LuminanceScaledSource} Eqn 5c

These are used to calculate a blended target XYZ value for each RGB combination in the input sample set (9). These blended target XYZ values may then be converted to L*a*b* values using the well-known conversion to produce the blended target L*a*b* sample set values (10). This conversion needs a reference white XYZ value set, which should be those of the luminance scaled source white point.

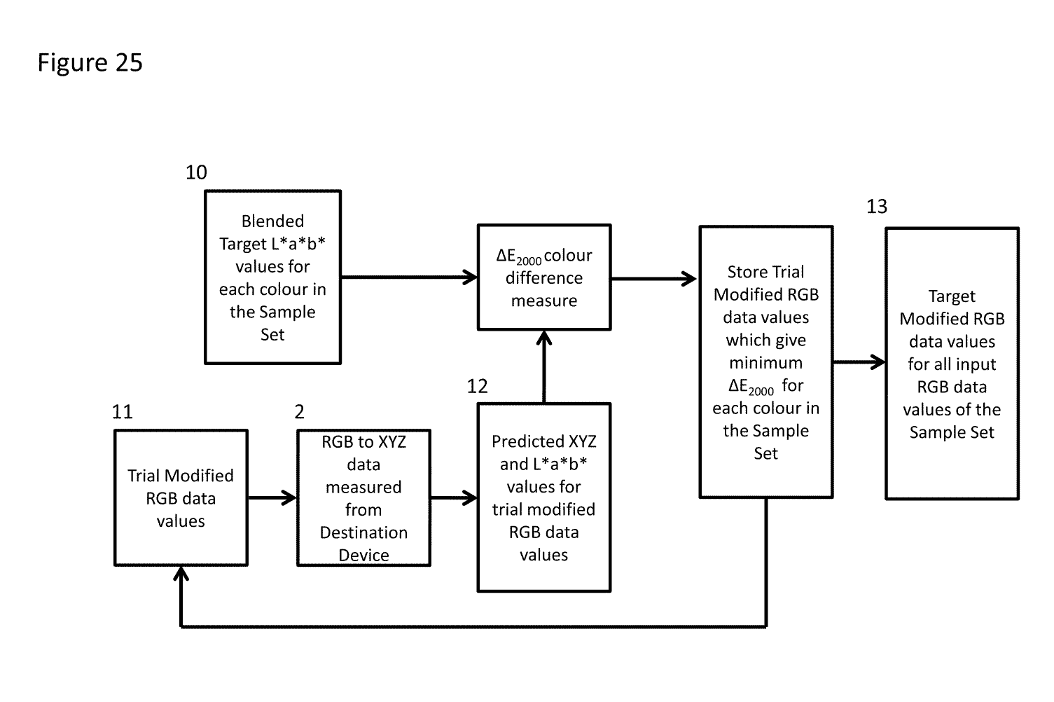

These blended target L*a*b* sample set values (10) are then used in the trial-and-error process illustrated in FIG. 25, in which a for each RGB combination of the sample set (1), a series of trial modified RGB combinations (11) are tested by using the equations 1a-1c in conjunction with the destination RGB to XYZ data (2) to find predicted XYZ values which the trial combination would produce on the destination device, which may then be converted to L*a*b* values (12). The ΔE₂₀₀₀ colour difference between the predicted destination L*a*b* values produced by the trial modified RGB values and the blended target L*a*b* values of the sample set colour is then found. The trial modified RGB values producing the minimum ΔE₂₀₀₀ colour difference from the blended target L*a*b* values are stored, and the process is repeated for each colour in the sample set. The stored values then complete the target modified RGB data value sample set (13).

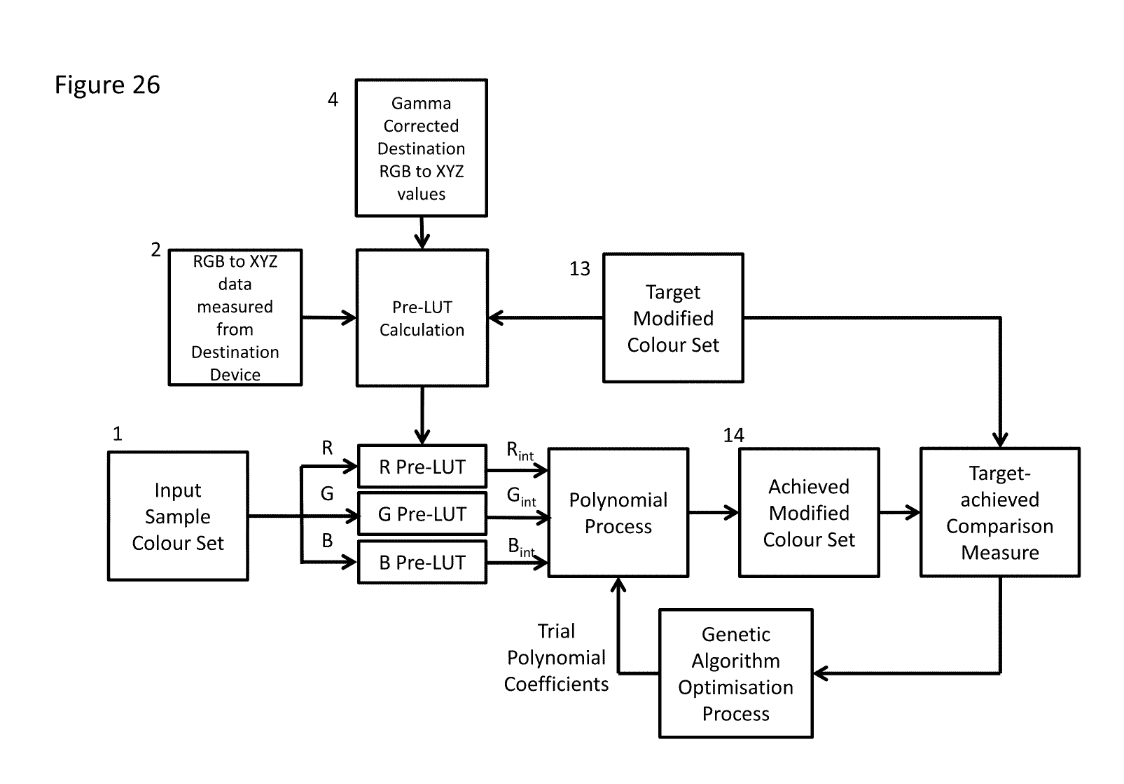

The target modified RGB data value sample set (13) and the input sample colour set (1) are then used in the polynomial coefficient optimisation process of FIG. 26. In this process, Pre-LUT values for conversion of the RGB values of each colour of the sample set to intermediate RGB values are calculated for each input of 0 to 255 for each colour channel by taking the average of the R, G or B values which produce on the destination display the closest match to the gamma corrected XYZ values for that input in the gamma corrected RGB to XYZ data set, and the R, G or B value from the target modified RGB sample set corresponding to that the grey colour with R, G and B values all equal to that input. E.g. for an input level of 161, it may be found that the RGB input in the RGB to XYZ data set (2) giving the best match to the gamma corrected XYZ values for the input [0,161,0] in the gamma correct RGB to XYZ data set (4) are [0,150,0], while the target modified RGB values corresponding to the input [161,161,161] in the sample set (13) are [167,138,106]. The G Pre-LUT output for an entry of G=161 would then be (150+138)/2=144.

The pre-LUTs are then used in conjunction with trial polynomial coefficients to calculate modified RGB data values for every input RGB combination in the sample set (1). These achieved modified RGB values (14) are compared with the target modified RGB values (13) to produce a measure of the accuracy of the combine Pre-LUT and polynomial process in its aim of converting all the RGB combination of the input set into those of the target modified set. This measure may be simply a sum of the absolute differences in each R, G and B value of each combination in the input and target modified sample set, or it may be a square of those differences.

A genetic algorithm which iteratively modifies the set of polynomial coefficients towards the goal of minimising the comparison error measure is used to find optimum coefficients. It can be seen that the specific details described in this exemplary embodiment and illustrated in FIGS. 22-26 form a complete means of providing the perceptual gamut mapping algorithm and numerical optimisation processes of FIG. 19, and provide a method of optimising Pre-LUT values and polynomial coefficients for a display colour conversion process of the type of FIG. 7, based solely on CIE 1931 XYZ measurements of a set of sample colours on the display, and either calculation or measurements of the XYZ values of second colour set according to a known standard or on a source intention display.

This process was used with the non-standard display of previous examples in conjunction with calculated sRGB source intention inputs with to produce the performance shown in FIG. 9, and with the source intention input measured on the TV panel in “dynamic mode” to produce the performance shown in FIGS. 14 and 15.

The Pre-LUT and polynomial coefficients may also be further optimised by an iterative process which allows modification of the Pre-LUT values after optimised Polynomial coefficients have been found in conjunction with the initially calculated Pre-LUT values. This may use a similar numerical optimisation process to find modified Pre-LUT values which work in conjunction with the existing optimised polynomial process to produce a better match of the achieved modified RGB sample set to the target modified sample set. Further iterations may be applied subsequently using the numerical optimisation process again to find further optimised polynomial coefficients, to operate in conjunction with the newly modified Pre-LUT values and so on.

Alternatively, to save computational time, the Pre-LUT modification part of this feedback loop could take into account only the pure grey entries (R, G and B values all equal) in the sample set, before again optimising the polynomial coefficients for all entries in the sample set.

Alternatively, the Pre-LUT values themselves could be included as trial parameters with the polynomial coefficients to be optimised simultaneously in a single process.

It may be noted that in the optimised polynomial parameters given for the examples of the non-standard display operating with sRGB source intention in FIG. 8 and with the TV “dynamic mode” source intention in FIG. 13, all the polynomial parameters r₁₂ to r₂₀ g₁₂ to g₂₀ and b₁₂ to b₂₀ are set to 0. This is because it was found that the Pre-LUT and polynomial process were able to achieve satisfactory colour performance on the non-standard display without the need for the influence of these polynomial terms on the outcome. In this case, the computational processing power and memory storage may be saved by only implementing a polynomial process with the terms 1-11.

It also may be noted that the additional image data processing steps required to implement the above described methods in the image data flow of a display device may be assisted by existing image manipulation process in the display device. For example, most LCD display devices use a LUT function in the digital-to-analogue converter (DAC) which converts the input digital image data into analogue voltages for application to each pixel electrode. This conversion is usually configured to take into account the voltage-to-luminance response of the LCD and the intended data value to luminance curve of the expected source data intention. It may however be configured to operate in conjunction with the Pre-LUTs and polynomial processes of this invention to allow further improved colour performance.

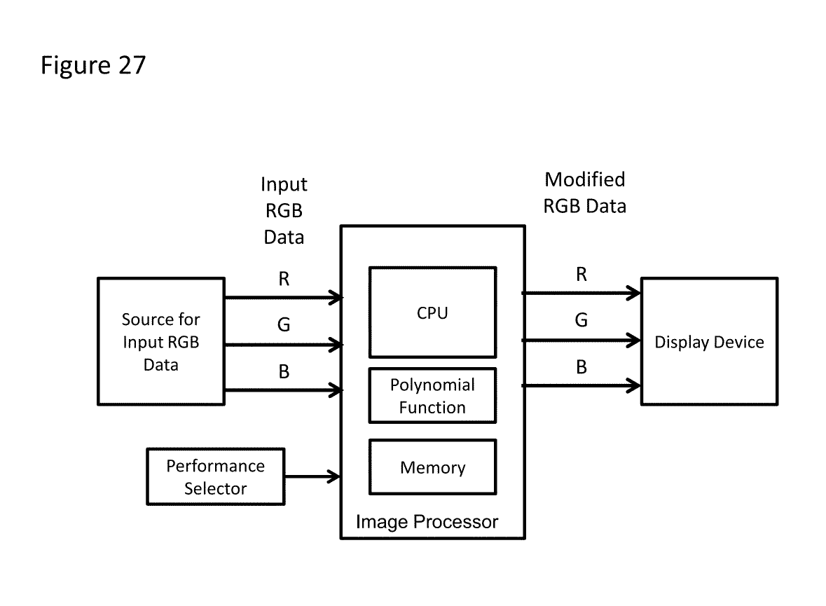

FIG. 27 illustrates an exemplary image processor incorporating the image data conversion process described herein. The source for the input RGB data may be any type of source of image data including, for example, a camera, video camera, broadcast signal, image rendering software, etc. The image processor includes a digital processor (e.g., one or more CPUs) which executes a program stored in non-transitory, computer-readable medium (e.g., ROM, RAM, hard drive, solid state drive, optical disk, etc.) to carry out the functions described herein. The image processor receives the input RGB data from the source, and the processor causes the polynomial function as described herein to operate upon the input RGB data to produce the modified RGB data which is output from the image processor. The modified RGB data is output to the destination display device whose colour gamut represents the destination gamut. The display device may be any type of display device such as a liquid crystal display (LCD), plasma display, organic light emitting device (OLED) display, cathode ray tube (CRT) display, etc.

The image processor may also be configured to receive an input from a performance selector to implement various user or device control as described herein. For example, the performance selector may be a user input or device interface by which the pre-LUT and/or polynomial coefficients may be changed to switch the colour performance of the display device.

The image processor may represent a stand-alone device, or be incorporated within the source for the input RGB data or the display device itself. For example, the image processor may be included in the driver circuitry of the display device. Alternatively, the image processor function may be included in a computing device as part of its image rendering program or image data output processing.

The non-transitory, computer readable medium storing a computer program which, when executed by a processor, causes the processor to carry out the image processor function described herein represents a further embodiment.

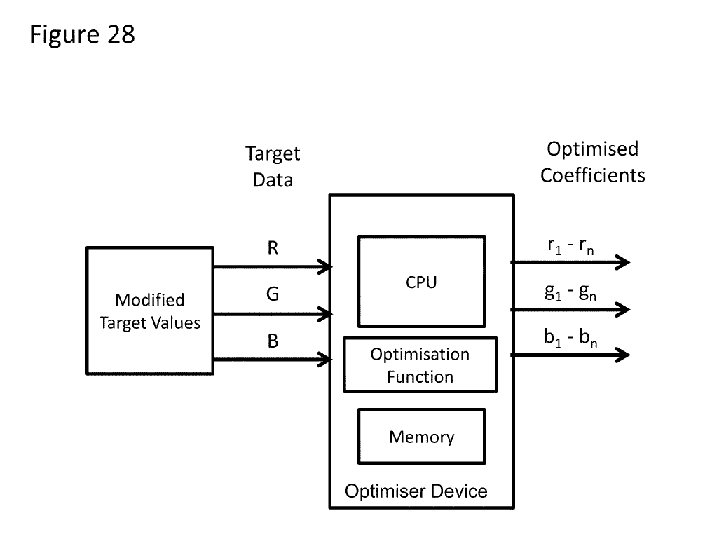

FIG. 28 represents an exemplary optimiser device which optimises the polynomial function coefficients according to any of the techniques described above. The optimiser device includes a digital processor (e.g., one or more CPUs) which executes a program stored in non-transitory, computer-readable medium (e.g., ROM, RAM, hard drive, solid state drive, optical disk, etc.) to carry out the optimisation functions described herein (e.g., FIGS. 18-22 and 26). The optimiser device receives the modified target values, and the processor optimises the coefficients of the polynomial function using numerical optimisation, etc., as described herein. The optimised coefficients are then output.

The non-transitory, computer readable medium storing a computer program which, when executed by a processor, causes the processor to carry out the optimiser device function described herein represents a further embodiment.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

The invention described herein may be applicable to displays used in mobile devices such as telephones, tablet and portable PCs, televisions and public information displays, wherever the display colour performance may not inherently conform to a given standard, or where the source intention of data input to the display may vary in different usage scenarios, or where the display is required to operate in a variety of colour modes.

1. A method for converting image data within a source gamut into modified image data within a destination gamut, comprising:
utilizing a processor to operate on input red-green-blue (RGB) data within the source gamut with a multivariate polynomial function to produce modified RGB data within the destination gamut,
wherein the polynomial function includes coefficients optimized in accordance with a predefined criteria such that when displayed on a display device having the destination gamut the modified RGB data have a colour appearance representing a perceptually optimised transform of the input RGB data.

2. The method according to claim 1, wherein operation of the polynomial function on the input RGB data produces modified RGB data which are accurate in colour appearance for a range of memory colours, display saturated colours (those which are at edges of the source gamut) at corresponding positions at edges of the destination gamut, and display blended intermediate output colours for colours in between the range of memory colours and the saturated colours in the source gamut.

3. The method according to claim 1, wherein the predefined criteria is based on calculating perceptually optimised modified target RGB data values in the destination gamut for a set of input RGB data values in the source gamut, and using a numerical optimisation process to minimise a difference between the modified RGB data values achieved by the polynomial function and the modified target RGB data values.

4. The method according to claim 1, comprising changing the polynomial function coefficients in accordance with a performance selector input in order to switch colour performance of the display device.

5. The method according to claim 1, comprising using a 1-dimensional look-up table (LUT) to convert each of the input R, G and B data values in the input RGB data separately to intermediate R, G and B data values, and subsequently inputting the intermediate R, G and B data values to the polynomial function.

6. The method according to claim 1, comprising changing the LUT in accordance with a performance selector input in order to switch colour performance of the display device.

7. A display device comprising drive circuitry which carries out the method of claim 1.

8. A computing device comprising at least one of an image rendering program or image data output processor which carries out the method of claim 1.

9. A non-transitory, computer-readable medium having stored thereon a program which, when executed by a processor, carries out the method of claim 1.

10. A method for optimizing coefficients of a multivariate polynomial function with which input RGB data within a source gamut is to be converted into modified RGB data within a destination gamut, comprising:
optimizing the coefficients in accordance with a predefined criteria using a processor such that when displayed on a display device having the destination gamut the modified RGB data have a colour appearance representing a perceptually optimised transform of the input RGB data.

11. The method according to claim 10, wherein the predefined criteria comprises minimising a difference between the modified RGB data values achieved by the polynomial function and modified target RGB data values.

12. The method according to claim 10, wherein the optimising of the coefficients is performed in conjunction with a 1-dimensional look-up table (LUT) to convert each of the input R, G and B data values in the input RGB data separately to intermediate R, G and B data values, and subsequently inputting the intermediate R, G and B data values to the polynomial function.

13. The method according to claim 12, wherein values in the LUT and the polynomial coefficients are optimised sequentially in a feedback loop process.

14. An optimiser device comprising a processor programmed to carry out the method of claim 10.

15. A non-transitory, computer-readable medium having stored thereon a program which, when executed by a processor, carries out the method of claim 10.
